(19) United States
(12) Patent Application Publication
(10) Pub. No.: US 2010/0281901 A1
(43) Pub. Date: Nov. 11, 2010

(54) Air conditioner for vehicle

(75) Inventors: Yasuhiro Kawase, Nishio-city (JP); Yukikatsu Ozaki, Gamagori-city (JP); Mitsuo Inagaki, Okazaki-city (JP)

Correspondence Address: HARNESS, DICKEY & PIERCE, P.L.C., P.O. BOX 828, BLOOMFIELD HILLS, MI, 48303, US

(73) Assignee: Nippon Soken, Inc., Nishio-city (JP)

(21) Appl. No.: 12/799,905

(22) Filed: May 4, 2010

(30) Foreign Application Priority Data
May 7, 2009 (JP) 2009-112986

(51) Int. Cl. F25B 27/00; B60H 3/00; F25B 41/00; F25B 13/00; F25B 43/00; F28D 1/00

(52) U.S. Cl. 62/238.7; 165/42; 62/513; 62/324.6; 62/512; 165/148

(57) ABSTRACT

In an air conditioner for a vehicle, in a heating operation for heating a vehicle compartment, when heating capacity is obtained by flowing a coolant through an inside of an indoor heat exchanger, the coolant flows directly in the inside of the indoor heat exchanger to heat air to be supplied to the vehicle compartment. In contrast, when the heating capacity is not obtained by flowing the coolant through the inside of the indoor heat exchanger, the coolant flows through a first water-refrigerant heat exchanger and a refrigerant in a heat pump cycle circulates so that heat of the coolant is absorbed by the refrigerant in the first water-refrigerant heat exchanger, and the air is heated in the indoor heat exchanger by using heat of the refrigerant that has absorbed the heat of the coolant.

### CROSS REFERENCE TO RELATED APPLICATION

The present application is based on Japanese Patent Application No. 2009-112986 filed on May 7, 2009, the disclosure of which is incorporated herein by reference.

### FIELD OF THE INVENTION

The present invention relates to an air conditioner for a vehicle (also referred to as a vehicle air conditioner), in which an engine coolant is used as a heat source for a heater.

### BACKGROUND OF THE INVENTION

For example, according to a conventional vehicle air conditioner described in JP-A-11-170848, in a heating operation in a vehicle compartment, a coolant after cooling an engine, which is introduced to a heater core, is used as a heat source for a heater and air heated in a sub-condenser with the use of a high temperature refrigerant by a heat pump is used as a heat source for a heater.

In the conventional technique, when the engine is operated, air in a duct of the air conditioner is heated by the coolant introduced to the heater core so that the heating operation is performed. In contrast, when the engine is not operated, an electric compressor is operated to introduce the high temperature refrigerant into the sub-condenser and air in the duct is heated so that the heating operation is performed. Further, until a temperature of the refrigerant flowing through the sub-condenser becomes high enough to perform the heating operation, the engine needs to maintain an idling condition, and the coolant is introduced to the heater core so that the heating operation is performed by using both the heater core and the sub-condenser.

However, in the conventional technique, the sufficient feeling of heat cannot be obtained when the coolant temperature is low at the starting of the engine operation, for example. Further, in order to improve the heating capacity by increasing the amount of heat supplied from the heater core, the engine should be excessively operated with respect to an operation state of the vehicle, resulting in decreasing the operation efficiency of the engine.

### SUMMARY OF THE INVENTION

In view of the above points, it is an object of the present invention to provide an air conditioner for a vehicle, which can save force used for a heater.

According to one aspect of the present invention, an air conditioner for a vehicle includes a coolant circuit, a heat pump cycle and a heater. The coolant circuit is configured such that a coolant for cooling an engine for driving the vehicle circulates therein, and the coolant circuit is connected to the engine. The heat pump cycle is configured to condition air in a vehicle compartment by controlling a state of a refrigerant circulating therein and the heat pump cycle includes a compressor configured to draw and discharge the refrigerant, a high-pressure side heat exchanger configured to cool the refrigerant discharged from the compressor, a first decompression device configured to decompress the refrigerant flowing out of the high-pressure side heat exchanger, and a first water-refrigerant heat exchanger, through which the coolant in the coolant circuit and the refrigerant decompressed by the first decompression device are capable of flowing, configured such that heat is exchanged between the decompressed refrigerant and the coolant so that heat of the coolant is absorbed by the refrigerant. The heater is located in the vehicle compartment to heat the air by using heat of at least one of the coolant and the refrigerant. The coolant circuit and the heat pump cycle are configured to provide an indoor heat exchanger, and the indoor heat exchanger is configured such that heat is exchanged between air to be supplied to the vehicle compartment via an outside thereof and the refrigerant or the coolant flowing through an inside thereof. The heat pump cycle is configured such that the coolant flows directly in the inside of the indoor heat exchanger to heat the air to be supplied to the vehicle compartment when heating capacity is obtained by flowing the coolant through the inside of the indoor heat exchanger in a heating operation for heating the vehicle compartment. The heat pump cycle is configured such that the coolant flows through the first water-refrigerant heat exchanger, the refrigerant in the heat pump cycle circulates, the heat of the coolant is absorbed by the refrigerant in the first water-refrigerant heat exchanger, and the air to be supplied to the vehicle compartment is heated in the indoor heat exchanger by using heat of the refrigerant that has absorbed the heat of the coolant when the heating capacity is not obtained by flowing the coolant through the inside of the indoor heat exchanger in the heating operation.

According to the configuration, when the sufficient heating capacity is obtained from the coolant in the heating operation, the coolant flows in the indoor heat exchanger to heat air to be supplied to vehicle compartment. In contrast, when the sufficient heating capacity is not obtained from the coolant, the coolant flows through the first water-refrigerant heat exchanger and the heat of the coolant is absorbed by the refrigerant circulating in the heat pump cycle by the heat pump so that the heat that has been absorbed by the refrigerant is radiated in the indoor heat exchanger to heat the air. Further, heat of the refrigerant is radiated in the high-pressure side heat exchanger of the heat pump cycle so that the air is heated. The heating operation that uses the heat of the coolant for the heater can be obtained without increasing the coolant temperature as described in the conventional technique. Thus, the coolant temperature can be maintained low and energy loss due to the heat radiation in the engine can be decreased and further, exhaust heat from the engine is transferred efficiently to the refrigerant by the heat pump so that the heating capacity can be obtained. Therefore, the force for operating the heater can be saved, and the energy efficiency of the, entire vehicle and the fuel consumption can be improved.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic diagram that relates to a heating operation of a vehicle air conditioner according to a first embodiment of the present invention;

FIG. 2 is a block diagram that relates to the heating operation of the vehicle air conditioner;

FIG. 3 is a flow diagram showing a first example of control in the heating operation of the vehicle air conditioner;

FIG. 4 is a schematic diagram that relates to a heating operation of a vehicle air conditioner according to a second embodiment of the present invention;

FIG. 5 is a schematic diagram that relates to a heating operation of a vehicle air conditioner according to a third embodiment of the present invention;

FIG. 6 is a flow diagram showing a second example of control in the heating operation of the vehicle air conditioner;

FIG. 7 is a schematic diagram that relates to a heating operation of a vehicle air conditioner according to a fourth embodiment of the present invention;

FIG. 8 is a schematic diagram that relates to a heating operation of a vehicle air conditioner according to a fifth embodiment of the present invention;

FIG. 9 is a schematic diagram that relates to a heating operation of a vehicle air conditioner according to a sixth embodiment of the present invention;

FIG. 10 is a flow diagram showing a third example of control in the heating operation of the vehicle air conditioner; and

FIG. 11 is a schematic diagram that relates to a heating operation of a vehicle air conditioner according to a seventh embodiment of the present invention.

### DETAILED DESCRIPTION OF THE PREFERRED EMBODIMENTS

Hereinafter, embodiments of the present invention will be described with reference to the drawings. In the respective embodiments, a component in an embodiment, which is similar to a component in a precedent embodiment, will be designated by the same reference numeral with the component in the precedent embodiment, and a description thereof will not be repeated. In the case where only one part of a configuration is described in an embodiment, a configuration described in a precedent embodiment can be applied to the other part of the configuration. Further, when there is no contradiction, the embodiments can be combined each other even if the combination is not described in the respective embodiments.

### First Embodiment

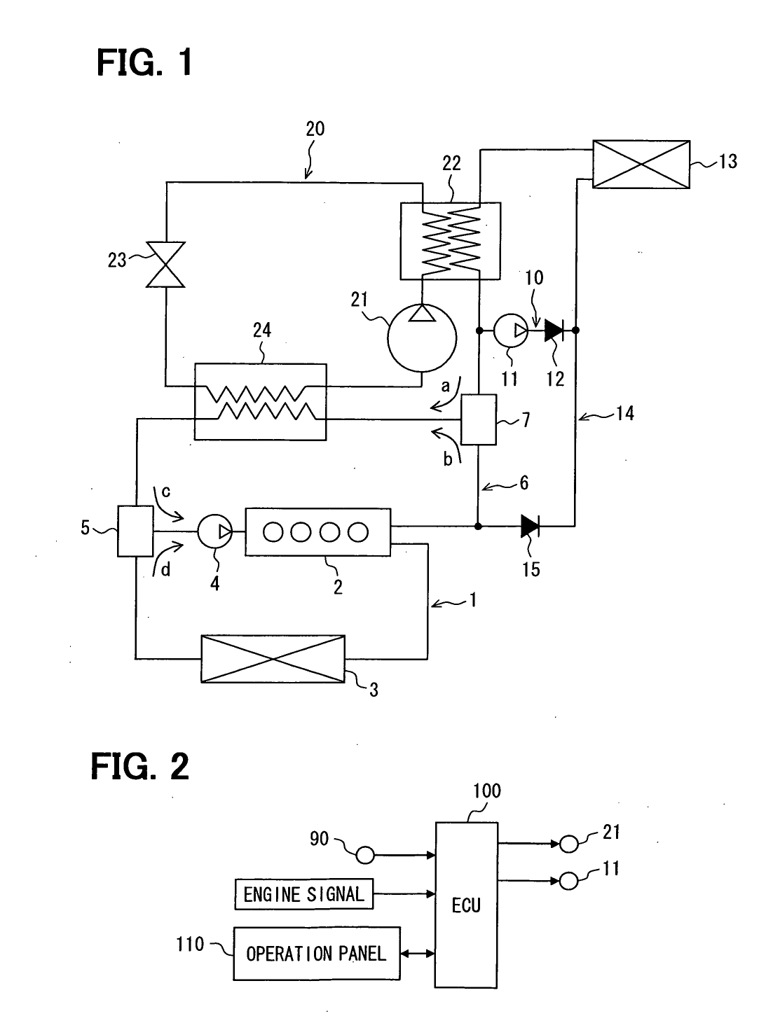

A vehicle air conditioner of a first embodiment of the present invention will be described with reference to FIGS. 1 to 3.

As shown in FIG. 1, the vehicle air conditioner is a circuit to which an engine 2 for driving a vehicle is connected, and includes a coolant circuit, in which a coolant for cooling the engine 2 circulates, and a vapor-compression type heat pump cycle 20 that conditions air in a vehicle compartment by controlling a state of a circulating refrigerant. Further, the vehicle air conditioner is a device that causes heat of at least one of the coolant and the refrigerant to be used for a heater in the vehicle compartment. The heat pump cycle 20 includes a compressor 21, a second water-refrigerant heat exchanger 22 as a high-pressure side heat exchanger, an expansion valve 23 and a first water-refrigerant heat exchanger 24 that exchanges heat between the coolant and the refrigerant, and configures a refrigerant circuit in which these components are circularly-connected.

The compressor 21 is a pump that draws, compresses and discharges a refrigerant having a low critical temperature such as carbon dioxide or the like. The compressor 21 is connected to the first water-refrigerant heat exchanger 24 at a draw side thereof, and is connected to the second water-refrigerant heat exchanger 22 at a discharge side thereof. The first water-refrigerant heat exchanger 24 includes a refrigerant passage in a part of a low-pressure side passage of the heat pump cycle 20 at the draw side of the compressor 21 and a water passage in a part of a second coolant circuit 6 described below, and is configured such that heat is exchanged between fluids flowing in the refrigerant passage and the water passage. The first water-refrigerant heat exchanger 24 is a heat exchanger that evaporates a low pressure refrigerant and cools a coolant.

The second water-refrigerant heat exchanger 22 is a high-pressure side heat exchanger that cools the refrigerant discharged from the compressor 21. The second water-refrigerant heat exchanger 22 includes a refrigerant passage in a part of a high-pressure side passage of the heat pump cycle 20 at the discharge side of the compressor 21 and a water passage in a part of a third coolant circuit 10 described below, and is configured such that heat is exchanged between fluids flowing in the refrigerant passage and the water passage. The second water-refrigerant heat exchanger 22 is a heat exchanger that transfers heat of a high pressure refrigerant to a coolant to heat the coolant. The expansion valve 23 is a first decompression device that decompresses the refrigerant flowing out of the second water-refrigerant heat exchanger 22, and causes the refrigerant flowing into the first water-refrigerant heat exchanger 24 to be a low pressure refrigerant. The expansion valve 23 may be a fixed type expansion valve or a flow-control type expansion valve.

A coolant circuit contributing to a heating operation of the vehicle air conditioner is constructed of a first coolant circuit 1, the second coolant circuit 6, the third coolant circuit 10 and a fourth coolant circuit 14. In the first coolant circuit 1, the coolant for cooling the engine 2 (for example, an antifreeze fluid such as LLC) circulates through a radiator 3 and the engine 2. In the second coolant circuit 6, the coolant circulates through the water passage of the first water-refrigerant heat exchanger 24 and the engine 2. In the third coolant circuit 10, the coolant circulates through the water passage of the second water-refrigerant heat exchanger 22 and the inside of an indoor heat exchanger 13. In the fourth coolant circuit 14, the coolant circulates through the water passage of the first water-refrigerant heat exchanger 24, the inside of the engine 2, the inside of the indoor heat exchanger 13 and the water passage of the second water-refrigerant heat exchanger 22.

The indoor heat exchanger 13 includes a water passage, in which the coolant of the third coolant circuit 10 flows, and an air passage. The indoor heat exchanger 13 is arranged in an air conditioning unit case (not shown) through which air to be blown into the vehicle compartment passes. In the indoor heat exchanger 13, heat is exchanged between the air to be blown into the vehicle compartment, which is sent by a blower fan (not shown), and the coolant, and thereby the air is heated by heat of the coolant.

The engine 2 is a water-cooled type internal combustion engine, and is cooled by the coolant that is sent into a water jacket of the engine 2 by a pump 4. The first coolant circuit 1 is a high temperature coolant circuit, in which a high temperature coolant flowing in the, water jacket of the engine 2 circulates. The first coolant circuit 1 includes the pump 4 that always pressure-sends the coolant, the radiator 3 that causes heat obtained by being heat-exchanged between the coolant and outside air to be radiated to the outside, and a thermostat 5 that separates a flow direction of the coolant into two streams.

The second coolant circuit 6 includes the water passage of the first water-refrigerant heat exchanger 24 and a water passage inside the engine 2. The coolant that has received heat from the engine 2 in the engine 2 circulates in the second coolant circuit 6 such that heat is radiated to the refrigerant in the first water-refrigerant heat exchanger 24. The second coolant circuit 6 has the thermostat 5 at a junction with the first coolant circuit 1 and a thermostat 7 at a junction with the fourth coolant circuit 14. The third coolant circuit 10 includes the water passage of the second water-refrigerant heat exchanger 22 and the water passage inside the indoor heat exchanger 13. The coolant heated by the refrigerant in the second water-refrigerant heat exchanger 22 circulates in the third coolant circuit 10 such that heat is radiated in the indoor heat exchanger 13. The third coolant circuit 10 has a pump 11 that pressure-sends the coolant when the heat pump cycle 20 is operated (i.e., when the refrigerant is circulating), and a check valve 12 that prevents the coolant flowing out of the pump 11 from flowing back to a side of the pump 11.

The fourth coolant circuit 14 includes the water passage of the first water-refrigerant heat exchanger 24, the inside of the engine 2, the water passage inside the indoor heat exchanger 13 and the water passage of the second water-refrigerant heat exchanger 22. In the fourth coolant circuit 14, the coolant that has received heat from the engine 2 in the engine 2 circulates through a check valve 15, the indoor heat exchanger 13, the second water-refrigerant heat exchanger 22, the thermostat 7, the first water-refrigerant heat exchanger 24, the thermostat 5, the pump 4 and the engine 2 in this order. The fourth coolant circuit 14 has the thermostat 7 at a junction with the second coolant circuit 6 and the check valve 15 that causes the coolant flowing out of the engine 2 to flow to a side of the indoor heat exchanger 13 without flowing back to a side of the engine 2.

The thermostat 5 automatically switches between a flow, in which the coolant flowing out of the engine 2 radiates heat in the radiator 3 and flows back to the engine 2 (indicated by the arrow d in FIG. 1, i.e., a circulating flow in the first coolant circuit 1), and a flow, in which the coolant flowing out of the first water-refrigerant heat exchanger 24 flows back to the engine 2 (indicated by the arrow c in FIG. 1), based on a detected coolant temperature. Further, the thermostat 5 may be configured to be capable of controlling the amount of the coolant which flows through the radiator 3 and the amount of the coolant which does not flow through the radiator 3. Specifically, in a warming-up state, a flow which does not flow through the radiator 3 is formed or the amount of the cooling which bypasses the radiator 3 is increased so that the warming-up is accelerated. That is, supercooling of the coolant due to the radiator 3 can be prevented.

The thermostat 5 switches to a passage, in which the coolant flowing out of the radiator 3 flows to the side of the engine 2 (indicated by the arrow d in FIG. 1), when the coolant temperature is equal to or higher than 90° C., and switches to a passage, in which the coolant flowing out of the first water-refrigerant heat exchanger 24 flows to the side of the engine 2 (indicated by the arrow c in FIG. 1), when the coolant temperature is lower than 90° C. In this manner, the thermostat 5 can switch between the flow, in which the coolant flowing out of the engine 2 radiates heat in the radiator 3 and flows back to the engine 2 (the circulating flow in the first coolant circuit 1), and the flow, in which the coolant flowing out of the first water-refrigerant heat exchanger 24 flows back to the engine 2.

The thermostat 7 automatically switches between a flow, in which the coolant flowing out of the engine 2 flows to the first water-refrigerant heat exchanger 24 (indicated by the arrow b in FIG. 1), and a flow, in which the coolant flowing out of the second water-refrigerant heat exchanger 22 flows to the first water-refrigerant heat exchanger 24 (indicated by the arrow a in FIG. 1), based on the detected coolant temperature. The thermostat 7 switches to a passage, in which the coolant flowing out of the engine 2 flows to a side of the first water-refrigerant heat exchanger 24 (indicated by the arrow b in FIG. 1), when the coolant temperature is lower than 55° C. At this time, because thermostat 5 switches to the passage, in which the coolant flowing out of the first water-refrigerant heat exchanger 24 flows to the side of the engine 2 (indicated by the arrow c in FIG. 1), the coolant flowing out of the engine 2 flows back to the engine 2 through the first water-refrigerant heat exchanger 24 (a circulating flow in the second coolant circuit 6).

The thermostat 7 switches to a passage, in which the coolant flowing out of the second water-refrigerant heat exchanger 22 flows to the side of the first water-refrigerant heat exchanger 24 (indicated by the arrow a in FIG. 1), when the coolant temperature is equal to or higher than 55° C. and lower than 90° C. At this time, because the thermostat 5 switches to the passage, in which the coolant flowing out of the first water-refrigerant heat exchanger 24 flows to the side of the engine 2 (indicated by the arrow c in FIG. 1), the coolant flowing out of the engine 2 flows back to the engine 2 through the indoor heat exchanger 13, the second water-refrigerant heat exchanger 22 and the first water-refrigerant heat exchanger 24 (a circulating flow in the fourth coolant circuit 14).

A control device 100 is an electronic control unit that controls the operation of the heat pump cycle 20 to control the air conditioning in the vehicle compartment, and controls such that the coolant circuits are switched and heat of the coolant is used in the heating operation. As shown in FIG. 2, the control device 100 includes a microcomputer, an input circuit to which an activation signal of the engine 2, signals from various switches on an operation panel 110 arranged on a front surface of the vehicle compartment, sensor signals from a temperature sensor 90 for detecting the coolant temperature and the like are input, and an output circuit that sends output signals to various actuators. The microcomputer is configured by memories such as a ROM (read-only memory) and a RAM (readable and writable memory), a CPU (central processing unit) and the like, and includes various programs that are used for calculations based on operation instructions sent from the operation panel 110 or the like. The control device 100 controls operations of the compressor 21, the pump 11 and the like based on the results of the calculations by the programs.

The control device 100 receives air-conditioner environmental information, air-conditioner operating-condition information and vehicle environmental information and performs calculations using the information to calculate capacity to be set of the compressor 21. The control device 100 is an amplifier for controlling the air conditioner. For example, the control device 100 outputs a capacity control signal corresponding to the calculated capacity as a current to a capacity control valve, and controls the capacity of the compressor 21. Further, the control device 100 receives the air-conditioner environmental information, the air-conditioner operating-condition information and the vehicle environmental information and performs calculations using the information to calculate the flow amount of the coolant discharged from the pump 11, and thereby the operation of the pump 11 is controlled.

When operation signals such as operating or stopping of the air conditioner and a preset temperature are input into the control device 100 due to the operation of the operation panel 110 by an occupant and detection signals of the sensors are input into the control device 100, the control device 100 performs calculations to determine an operation state of each of components by the programs. Accordingly, the operation of each of the components such as the compressor 21, the pump 11, the blower fan of the air conditioning unit, an inside/outside switching door and an air mix door (not shown) is controlled.

In the heating operation of the vehicle air conditioner, the flow of the coolant and the operation of the heat pump cycle 20 are controlled based on whether the desired heating capacity can be obtained by flowing the coolant through the indoor heat exchanger 13. As an example of a method for determining whether the desired heating capacity can be obtained, there is a method that uses the coolant temperature in the heating operation. In the present embodiment, the method will be described below.

In the case where the coolant temperature is lower than 55° C. in the heating operation (operation pattern 1), the heating capacity cannot be obtained by directly flowing the coolant through the indoor heat exchanger 13 (that is, by flowing the coolant in the fourth coolant circuit 14). Thus, the operations of the compressor 21 and the pump 11 are started by the control device 100, and the flow direction of the coolant is set to be a flow direction c (indicated by the arrow c in FIG. 1) by the thermostat 5 and a flow direction b (indicated by the arrow b in FIG. 1) by the thermostat 7 based on the coolant temperature. The refrigerant in the heat pump cycle 20 circulates, and the coolant flows so as to circulate in the second coolant circuit 6 and the third coolant circuit 10. The refrigerant heated by the coolant in the first water-refrigerant heat exchanger 24 is drawn into and compressed by the compressor 21 to become high pressure, and the compressed refrigerant heats the coolant circulating in the third coolant circuit 10 in the second water-refrigerant heat exchanger 22. The heated coolant heats air to be sent into the vehicle compartment in the indoor heat exchanger 13, and thereby heat is sent to the heater in the vehicle compartment.

In the case where the coolant temperature is equal to or higher than 55° C. and lower than 90° C. in the heating operation (operation pattern 2), the heating capacity can be obtained by directly flowing the coolant through the indoor heat exchanger 13. Thus, the operations of the compressor 21 and the pump 11 are stopped, and the flow direction of the coolant is set to be the flow direction c (indicated by the arrow c in FIG. 1) by the thermostat 5 and a flow direction a (indicated by the arrow a in FIG. 1) by the thermostat 7 based on the coolant temperature. The refrigerant in the heat pump cycle 20 does not circulate, and the coolant flows so as to circulate only in the fourth coolant circuit 14. Heat of the coolant heated in the engine 2 is supplied to the indoor heat exchanger 13, and heats air to be sent into the vehicle compartment, and thereby heat is sent to the heater in the vehicle compartment.

In the case where the coolant temperature is equal to or higher than 90° C. (operation pattern 3), when the heating operation is stopped, the coolant temperature is very high. Thus, the flow of the coolant is controlled so as to radiate heat of the coolant to the outside. In particular, the operations of the compressor 21 and the pump 11 are stopped, and the flow direction of the coolant is set to be a flow direction d (indicated by the arrow d in FIG. 1) by the thermostat 5 based on the coolant temperature. The refrigerant in the heat pump cycle 20 does not circulate, and the coolant flows so as to circulate only in the first coolant circuit 1. Heat of the coolant heated in the engine 2 is radiated in the radiator 3, and cooling of the coolant is continuously performed. In contrast, when the heating operation is started, although the coolant does not flow into the indoor heat exchanger 13 temporarily, the flow direction of the coolant is set to be the flow direction c (indicated by the arrow c in FIG. 1) by the thermostat 5 before the temperature of the coolant remained in the indoor heat exchanger 13 about 90° C. is lowered, and the circulating flow in the fourth coolant circuit 14 is started again. Heat of the coolant heated in the engine 2 is supplied to the indoor heat exchanger 13, and heats air to be sent into the vehicle compartment, and thereby heat is sent to the heater in the vehicle compartment.

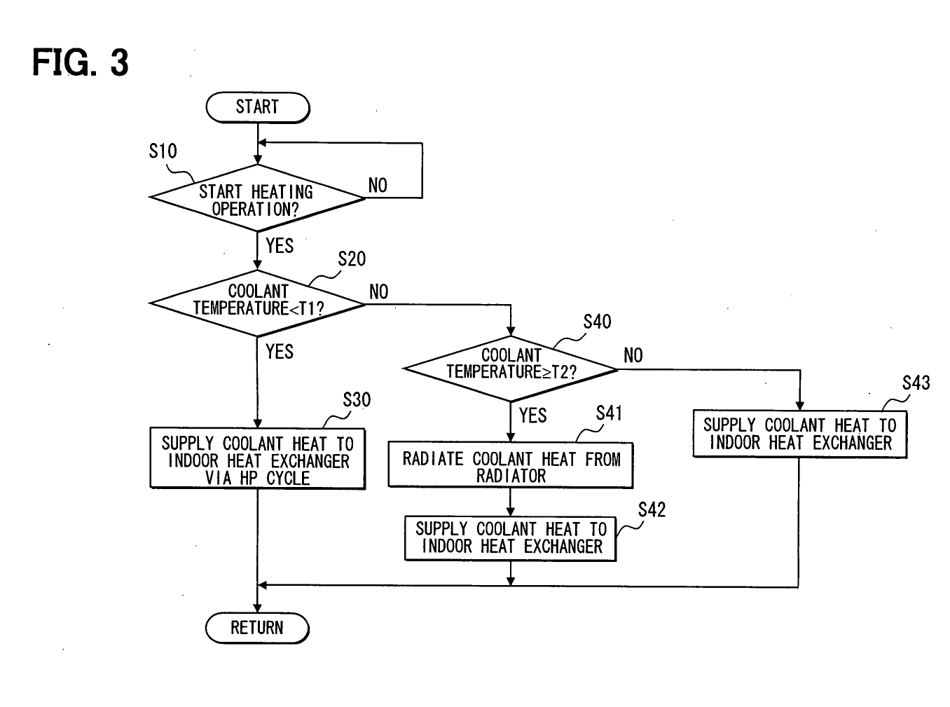

Next, the control of the vehicle air conditioner in the heating operation will be described with reference to FIG. 3. When an ignition switch is turned on and the power source is applied to the control device 100, the control device 100 determines whether the heating operation is started at S10 (S indicates step). A state that the heating operation is started includes a state that a heating operation signal in an operation of a manual air conditioner is input into the control device 100 due to the operation of the operation panel 110 by the occupant, or a state that a heating operation signal in an operation of an auto air conditioner is input into the control device 100. When it is determined that the heating operation is started at S10, it is determined whether the coolant temperature is lower than a predetermined temperature T1 (55° C., for example) at S20.

When it is determined that the coolant temperature is lower than the predetermined temperature. T1 at S20, the operation similar to that of the above-described operation pattern 1 is performed at S30. Then, returning to S10, the following processes are continuously performed. In this manner, heat of the low-temperature coolant is transferred to the refrigerant and the refrigerant is compressed by the compressor 21 to become a high pressure so that air to be sent into the vehicle compartment is heated in the indoor heat exchanger 13 via the high-pressure side heat exchanger. Thus, even when the coolant temperature is low, the heat of the coolant is transferred to the refrigerant to contribute to the heater and the heating capacity is further improved by the heat pump. Therefore, the heat radiated from the engine 2 can be effectively used for the heater, and the feeling of heat felt by the occupant can be improved.

When it is determined that the coolant temperature is equal to or higher than the predetermined temperature T1 at S20, the control device 100 further determines whether the coolant temperature is equal to or higher than a predetermined temperature T2 (90° C., for example) at S40. When it is determined that the coolant temperature is lower than the predetermined temperature T2 at S40, the operation similar to that of the above-described operation pattern 2 is performed at S43. Then, returning to S10, the following processes are continuously performed. In this manner, heat of the relatively high-temperature coolant is directly supplied to the indoor heat exchanger 13 so that air to be sent into the vehicle compartment is heated. Thus, when the coolant temperature is relatively high, i.e., the coolant temperature is equal to or higher than the predetermined temperature T1 and lower than the predetermined temperature T2, the air is heated only by the heat of the coolant to obtain the heating capacity. Therefore, the heat radiated from the engine 2 can be effectively used for the heater, force for operating the compressor and heat loss in exchanging heat can be decreased, and force for operating the heater in the entire vehicle can be suppressed.

When it is determined that the coolant temperature is equal to or higher than the predetermined temperature T2 at S40, the operation similar to that of the above-described operation pattern 3 is performed at S41 and S42. Then, returning to S10, the following processes are continuously performed. The high-temperature coolant needs to be cooled. Thus, at S41, the heat of the coolant is radiated from the radiator 3 to cool the engine 2. Moreover, in the heating operation, the heat of the coolant needs to be used for the heater. Thus, at S42, the process for forming the circulating flow in the fourth coolant circuit 14 is performed before the temperature of the coolant remained in the indoor heat exchanger 13 about 90° C. is lowered, and thereby air is heated only by the heat of the coolant heated in the engine 2 to obtain the heating capacity.

Hereinafter, the effect obtained by the vehicle air conditioner of the present embodiment will be described. The vehicle air conditioner includes the coolant circuit, in which the coolant for cooling the engine 2 circulates, and the heat pump cycle 20 that conditions air in the vehicle compartment by controlling a state of the circulating refrigerant. The vehicle air conditioner is an air conditioner that causes heat of at least one of the coolant and the refrigerant to be used for the heater in the vehicle compartment. The heat pump cycle 20 includes the compressor 21 that draws and discharges the refrigerant, the second water-refrigerant heat exchanger 22 (the high-pressure side heat exchanger) that cools the refrigerant discharged from the compressor 21, the expansion valve 23 that decompresses the refrigerant flowing out of the second water-refrigerant heat exchanger 22, and the first water-refrigerant heat exchanger 24. The first water-refrigerant heat exchanger 24 is configured such that each of the coolant in the coolant circuit and the refrigerant decompressed by the expansion valve 23 can flow therethrough, and causes the refrigerant to absorb heat of the coolant by exchanging heat between the decompressed refrigerant and the coolant. Further, the vehicle air conditioner includes the indoor heat exchanger 13, in which heat is exchanged between the air flowing through the outside thereof to be supplied to the vehicle compartment and the refrigerant or the coolant flowing through the inside thereof.

In the vehicle air conditioner, when the heating capacity can be obtained by flowing the coolant through the inside of the indoor heat exchanger 13 in the heating operation for heating the vehicle compartment, the coolant flows directly in the inside of the indoor heat exchanger 13 to heat air. In particular, circulating of the refrigerant in the heat pump cycle 20 is stopped, and the coolant circulates in the fourth coolant circuit 14. Further, when the heating capacity cannot be obtained by flowing the coolant through the inside of the indoor heat exchanger 13, the coolant flows through the first water-refrigerant heat exchanger 24 and the refrigerant in the heat pump cycle 20 circulates so that heat of the coolant is absorbed by the refrigerant in the first water-refrigerant heat exchanger 24. Then, air is heated in the indoor heat exchanger 13 by using heat of the refrigerant that has absorbed the heat of the coolant. In particular, the refrigerant circulates in the heat pump cycle 20, and the coolant circulates in the second coolant circuit 6 and the third coolant circuit 10, respectively. That is, according to the vehicle air conditioner of the present embodiment, because a circuit in which the coolant circulates is appropriately switched so as to efficiently transfer the heat of the coolant via the refrigerant in the heat pump cycle, the heat of the coolant can be used efficiently for the heater, without increasing the coolant temperature as described in the conventional technique.

According to the configuration, when the sufficient heating capacity can be obtained from the coolant in the heating operation (i.e., in the operation pattern 2), the coolant flows in the indoor heat exchanger 13 to heat air to be supplied to the vehicle compartment. Further, when the sufficient heating capacity cannot be obtained from the coolant (i.e., in the operation pattern 1), the coolant flows through the first water-refrigerant heat exchanger 24 and the heat of the coolant is absorbed by the refrigerant circulating in the heat pump cycle 20 by the heat pump so that the heat that has been absorbed by the refrigerant is radiated in the indoor heat exchanger 13 to heat air. Heat of the refrigerant that becomes further high temperature by being compressed by the compressor 21 is radiated in the high-pressure side heat exchanger, and the heat is transferred to air so that the air is heated.

Moreover, in order to decrease the heat loss from the engine and increase the energy efficiency, the coolant temperature needs to be lowered. However, if the coolant temperature is lowered, it becomes difficult to obtain the heating capacity. According to the vehicle air conditioner of the present embodiment, even when the coolant temperature is so low that the sufficient heating capacity cannot be obtained, the heat of the coolant is used in combination with the refrigerant circulating in the heat pump cycle 20 to transfer the heat to air, and the heating operation, in which the passage that can be used for the heater is formed, can be performed. Thus, the coolant temperature can be maintained low and energy loss due to the heat radiation in the engine 2 can be decreased, and exhaust heat from the engine 2 is transferred efficiently to the refrigerant by the heat pump so that the heating capacity can be obtained. Therefore, the heating capacity can be obtained with the coolant temperature maintained low, and the force for operating the heater can be saved, resulting in improving the energy efficiency of the entire vehicle and the fuel consumption.

In a conventional hybrid vehicle, in the case where the engine needs not to be driven for running, when the heating operation is started, the engine is driven and the heat of the engine is used for the heater. According to the vehicle air conditioner of the present embodiment, the driving of the engine for the heater needs not to be performed even when the coolant temperature is low. Therefore, compared with the conventional vehicle, the operation rate of the engine can be decreased and the energy efficiency of the entire vehicle can be improved.

Further, in the conventional vehicle, when the coolant temperature is low, the coolant flows through the indoor heat exchanger, but air is not blown to the indoor heat exchanger. When the coolant temperature is increased, air is' blown to the indoor heat exchanger to obtain the heating capacity. According to the vehicle air conditioner of the present embodiment, even when the coolant temperature is low, the heating capacity is obtained by transferring the heat of the coolant to the refrigerant by the heat pump. Thus, it becomes easy for a temperature in the vehicle compartment in the heating operation to be increased, and the feeling of heat felt by the occupant can be improved.

### Second Embodiment

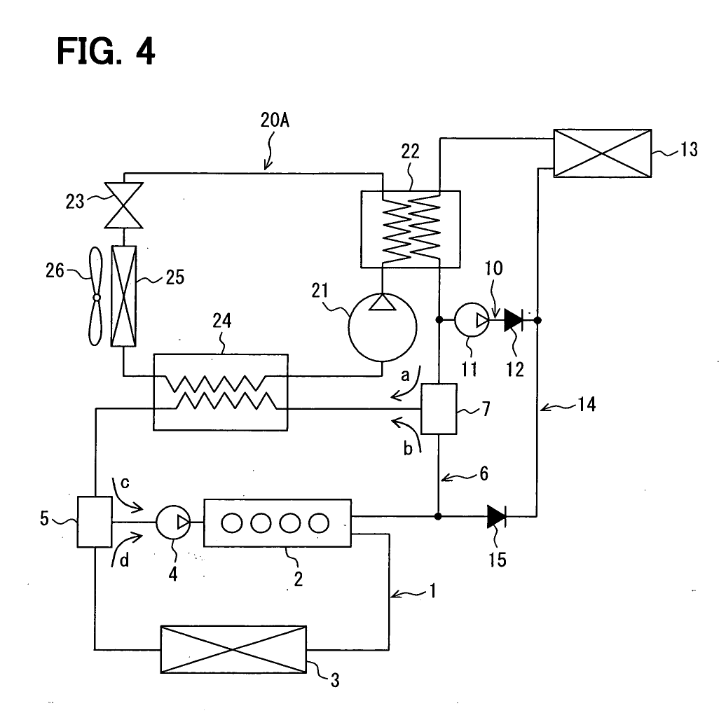

In a second embodiment, another example of the vehicle air conditioner of the first embodiment will be described with reference to FIG. 4. A component in FIG. 4, which is designated by the same reference numeral with the component in FIG. 1, is the same component with that of the first embodiment, and has the similar effect described In the first embodiment.

As shown in FIG. 4, a heat pump cycle 20A of a vehicle air conditioner of the present embodiment differs from the-heat pump cycle 20 of the first embodiment in that an outdoor heat exchanger 25 is arranged at a discharge side of the expansion valve 23 as the first decompression device. The outdoor heat exchanger 25 is a heat exchanger configured such that a refrigerant circulating in the heat pump cycle 20A flows through the inside thereof and outdoor air to be heat-exchanged with the refrigerant flows through the outside thereof. Further, a blower fan 26 for blowing the outdoor air is arranged adjacent to the outdoor heat exchanger 25.

In the present embodiment, in addition to the function above-described in the first embodiment, the control device 100 performs calculations based on stored programs using the received air-conditioner environmental information, air-conditioner operating-condition information and vehicle environmental information to calculate the rotation frequency of the blower fan 26 (i.e., the amount of blown air), and thereby the operation of the blower fan 26 is controlled.

Hereinafter, the control of the vehicle air conditioner according to the present embodiment in the heating operation will be described. Operation patterns 1A, 2A, 3A described below correspond to the operation patterns 1, 2, 3, which are described based on the flow diagram of FIG. 3 in the first embodiment, respectively.

In the case where the coolant temperature is lower than 55° C. in the heating operation (operation pattern 1A), the operations of the compressor 21, the pump 11 and the blower fan 26 are started by the control device 100, and the flow direction of the coolant is set to be the flow direction c (indicated by the arrow c in FIG. 4) by the thermostat 5 and the flow direction b (indicated by the arrow b in FIG. 4) by the thermostat 7 based on the coolant temperature. The refrigerant in the heat pump cycle 20A circulates, and the coolant flows so as to circulate in the second coolant circuit 6 and the third coolant circuit 10. The low pressure refrigerant that has been decompressed by the expansion valve 23 absorbs heat from the outside air in the outdoor heat exchanger 25, and is heated by the coolant in the first water-refrigerant heat exchanger 24. Then, the refrigerant is drawn into and compressed by the compressor 21 to become high pressure, and the compressed refrigerant heats the coolant circulating in the third coolant circuit 10 in the second water-refrigerant heat exchanger 22. The heated coolant heats air to be sent into the vehicle compartment in the indoor heat exchanger 13, and thereby heat is sent to the heater in the vehicle compartment.

In the case where the coolant temperature is equal to or higher than 55° C. and lower than 90° C. in the heating operation (operation pattern 2A), the operations of the compressor 21, the pump 11 and the blower fan 26 are stopped, and the flow direction of the coolant is set to be the flow direction c (indicated by the arrow c in FIG. 4) by the thermostat 5 and the flow direction a (indicated by the arrow a in FIG. 4) by the thermostat 7 based on the coolant temperature. The refrigerant in the heat pump cycle 20A does not circulate, and the coolant flows so as to circulate only in the fourth coolant circuit 14. Heat of the coolant heated in the engine 2 is supplied to the indoor heat exchanger 13, and heats air to be sent into the vehicle compartment, and thereby heat is sent to the heater in the vehicle compartment.

In the case where the coolant temperature is equal to or higher than 90° C. (operation pattern 3A), when the heating operation is stopped, the operations of the compressor 21, the pump 11 and the blower fan 26 are stopped, and the flow direction of the coolant is set to be the flow direction d (indicated by the arrow d in FIG. 4) by the thermostat 5 based on the coolant temperature. The refrigerant in the heat pump cycle 20A does not circulate; and the coolant flows so as to circulate only in the first coolant circuit 1. Heat of the coolant heated in the engine 2 is radiated in the radiator 3, and cooling of the coolant is continuously performed. In contrast, when the heating operation is started, although the coolant does not flow into the indoor heat exchanger 13 temporarily, the flow direction of the coolant is set to be the flow direction c (indicated by the arrow c in FIG. 4) by the thermostat 5 before the temperature of the coolant remained in the indoor heat exchanger 13 about 90° C. is lowered, and the circulating flow in the fourth coolant circuit 14 is started again. Heat of the coolant heated in the engine 2 is supplied to the indoor heat exchanger 13, and heats air to be sent into the vehicle compartment, and thereby heat is sent to the heater in the vehicle compartment.

According to the present embodiment, the vehicle air conditioner includes the heat pump cycle 20A having the outdoor heat exchanger 25 and the blower fan 26. The refrigerant decompressed by the expansion valve 23 flows through the inside of the outdoor heat exchanger 25, and heat is exchanged between the refrigerant and the outdoor air in the outdoor heat exchanger 25. The blower fan 26 blows the outdoor air to the outdoor heat exchanger 25. In the vehicle air conditioner, when the heating capacity cannot be obtained by flowing the coolant through the inside of the indoor heat exchanger 13 in the heating operation, the refrigerant in the heat pump cycle 20A circulates, the blower fan 26 is operated to blow the outdoor air to the outdoor heat exchanger 25, and the coolant flows through the first water-refrigerant heat exchanger 24.

Accordingly, when the sufficient heating capacity cannot be obtained from the coolant (i.e., in the operation pattern 1A), the coolant flows through the first water-refrigerant heat exchanger 24 and the heat of the coolant is absorbed by the refrigerant circulating in the heat pump cycle 20A by the heat pump so that the heat that has been absorbed by the refrigerant is radiated in the indoor heat exchanger 13 to heat air. Further, heat of the outdoor air is transferred to the refrigerant in the outdoor heat exchanger 25, and the heat of the refrigerant that has absorbed the heat of the outdoor air is radiated to the coolant circulating in the third coolant circuit 10 in the second water-refrigerant heat exchanger 22 (the high-pressure side heat exchanger) so that the amount of heat to the air for the heater is increased in the indoor heat exchanger 13. Therefore, the air for the heater obtained from the heat of the coolant, the heat of the outdoor air and the heat of the refrigerant compressed by the compressor 21 can be provided to the vehicle air conditioner, and thereby the heating capacity can be further improved compared with the first embodiment.

### Third Embodiment

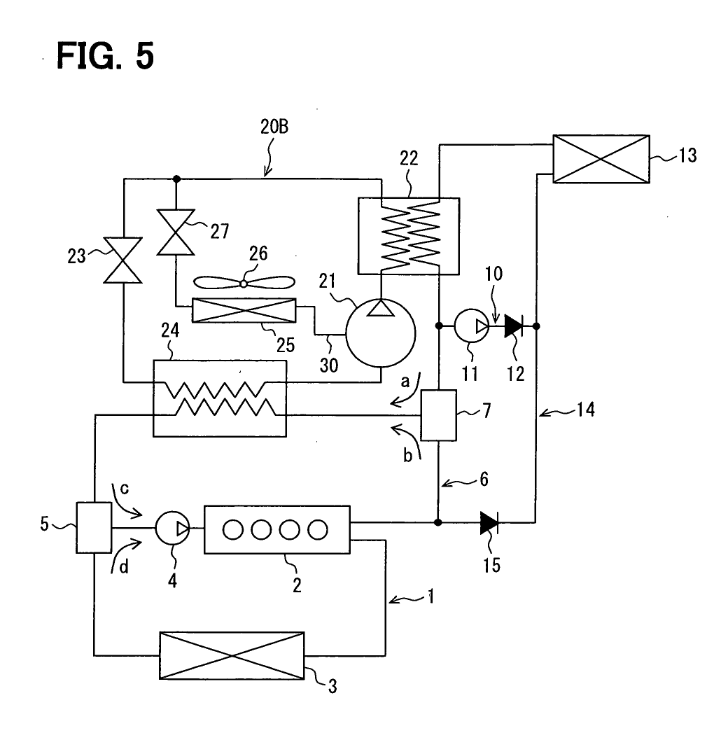

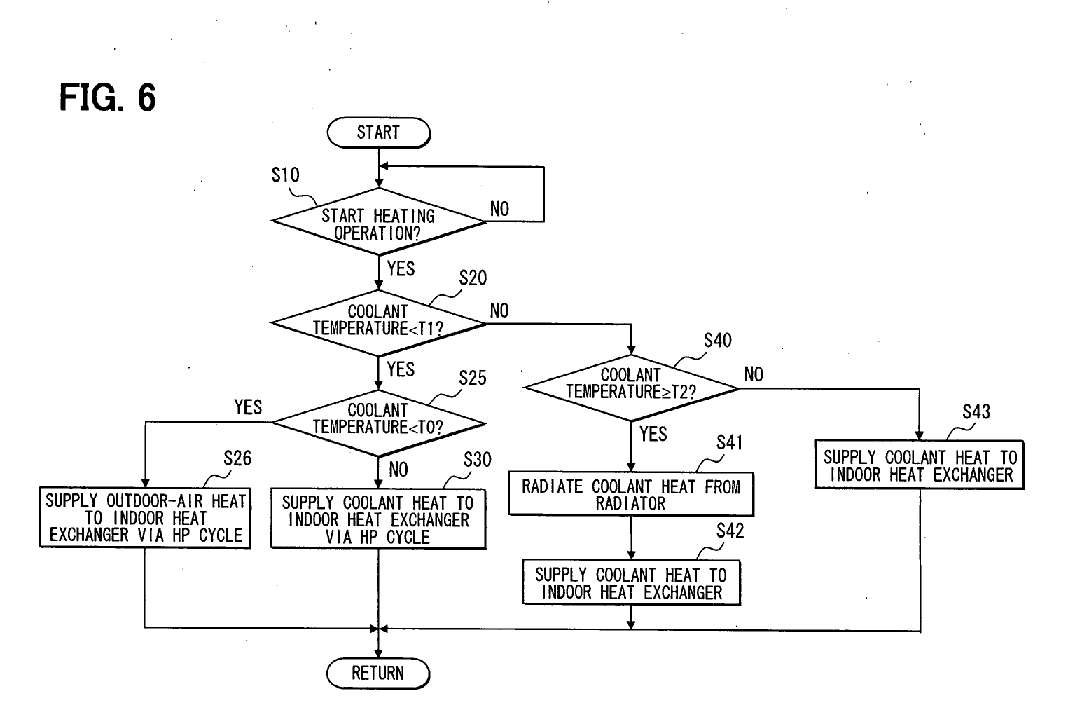

In a third embodiment, another example of the vehicle air conditioner of the first embodiment will be described with reference to FIGS. 5 and 6. A component or a step in FIGS. 5 and 6, which is designated by the same reference numeral with the component or the step in FIGS. 1 and 3, is the same component or the step with that of the first embodiment, and has the similar effect described in the first embodiment.

As shown in FIG. 5, a heat pump cycle 20B of a vehicle air conditioner of the present embodiment differs from the heat pump cycle 20 of the first embodiment in the following points. The heat pump cycle 20B has the refrigerant passage that is branched into a first refrigerant passage and a second refrigerant passage 30 at a discharge side of the second water-refrigerant heat exchanger 22. In the first refrigerant passage, the expansion valve 23 and the first water-refrigerant heat exchanger 24 are arranged in this order in the downstream direction. In the second refrigerant passage 30, an expansion valve 27 and the outdoor heat exchanger 25 are arranged in this order in the downstream direction. The outdoor heat exchanger 25 is a heat exchanger configured such that a refrigerant decompressed by the expansion valve 27 and flowing through the second refrigerant passage 30 flows through the inside thereof and outdoor air to be heat-exchanged with the refrigerant flows through the outside thereof. Further, the blower fan 26 for blowing the outdoor air is arranged adjacent to the outdoor heat exchanger 25. That is, the outdoor heat exchanger 25 is arranged in parallel with the first water-refrigerant heat exchanger 24 such that the refrigerant discharged from the compressor 21 flows into at least one of the first water-refrigerant heat exchanger 24 and the outdoor heat exchanger 25. The expansion valve 27 is a decompression device that decompresses the refrigerant flowing out of the second water-refrigerant heat exchanger 22 and into the second refrigerant passage 30, and causes the refrigerant flowing into the outdoor heat exchanger 25 to be a low pressure refrigerant. Each of the expansion valves 23, 27 of the present embodiment is a flow-control type expansion valve, and the opening degree thereof is controlled by the control device 100.

In the present embodiment, in addition to the function above-described in the first embodiment, the control device 100 performs calculations based on stored programs using the received air-conditioner environmental information, air-conditioner operating-condition information and vehicle environmental information to calculate the opening degrees of the expansion valves 23, 27, and thereby the operations of the expansion valves 23, 27 are controlled. Further, the control device 100 performs the above calculations to calculate the rotation frequency of the blower fan 26 (i.e., the amount of blown air), and thereby the operation of the blower fan 26 is controlled.

Hereinafter, the control of the vehicle air conditioner according to the present embodiment in the heating operation will be described.

In the case where the coolant temperature is lower than 55° C. in the heating operation (operation pattern 1B), for example, when the coolant temperature is equal to or higher than 0° C. and lower than 55° C., the operations of the compressor 21, the pump 11 and the blower fan 26 are started by the control device 100, the expansion valve 27 is controlled such that the opening degree thereof is zero, that is, the expansion valve 27 is totally closed, and the expansion valve 23 is controlled to be in an open state. Further, the flow direction of the coolant is set to be the flow direction c (indicated by the arrow c in FIG. 5) by the thermostat 5 and the flow direction b (indicated by the arrow b in FIG. 5) by the thermostat 7 based on the coolant temperature. The refrigerant in the heat pump cycle 20B circulates through the compressor 21, the second water-refrigerant heat exchanger 22, the expansion valve 23, the first water-refrigerant heat exchanger 24 and the compressor 21 in this order, and the coolant flows so as to circulate in the second coolant circuit 6 and the third coolant circuit 10. The low pressure refrigerant that has been decompressed by the expansion valve 23 is heated by the coolant in the first water-refrigerant heat exchanger 24. Then, the refrigerant is drawn into and compressed by the compressor 21 to become high pressure, and the compressed refrigerant heats the coolant circulating in the third coolant circuit 10 in the second water-refrigerant heat exchanger 22. The heated coolant heats air to be sent into the vehicle compartment in the indoor heat exchanger 13, and thereby heat is sent to the heater in the vehicle compartment (hereinafter referred to as operation pattern 1B-1).

For example, in operation pattern 1B, when the coolant temperature is lower than 0° C., it is determined that the amount of heat that can be absorbed from outdoor air is more than that from the coolant. The operations of the compressor 21, the pump 11 and the blower fan 26 are started by the control device 100, the expansion valve 23 is controlled such that the opening degree thereof is zero, that is, the expansion valve 23 is totally closed, and the expansion valve 27 is controlled to be in an open state. Further, the flow direction of the coolant is set to be the flow direction c (indicated by the arrow c in FIG. 5) by the thermostat 5 and the flow direction b (indicated by the arrow b in FIG. 5) by the thermostat 7 based on the coolant temperature. The refrigerant in the heat pump cycle 20B circulates through the compressor 21, the second water-refrigerant heat exchanger 22, the expansion valve 27, the outdoor heat exchanger 25 and the compressor 21 in this order, and the coolant flows so as to circulate in the second coolant circuit 6 and the third coolant circuit 10. The low pressure refrigerant that has been decompressed by the expansion valve 27 is heated by the outdoor air in the outdoor heat exchanger 25. Then, the refrigerant is drawn into and compressed by the compressor 21 to become high pressure, and the compressed refrigerant heats the coolant circulating in the third coolant circuit 10 in the second water-refrigerant heat exchanger 22 (hereinafter referred to as operation pattern 1B-2).

In the case where the coolant temperature is equal to or higher than 55° C. and lower than 90° C. in the heating operation (operation pattern 2B), the operations of the compressor 21, the pump 11 and the blower fan 26 are stopped, and the flow direction of the coolant is set to be the flow direction c (indicated by the arrow c in FIG. 5) by the thermostat 5 and the flow direction a (indicated by the arrow a in FIG. 5) by the thermostat 7 based on the coolant temperature. The refrigerant in the heat pump cycle 20B does not circulate, and the coolant flows so as to circulate only in the fourth coolant circuit 14. Heat of the coolant heated in the engine 2 is supplied to the indoor heat exchanger 13, and heats air to be sent into the vehicle compartment, and thereby heat is sent to the heater in the vehicle compartment.

In the case where the coolant temperature is equal to or higher than 90° C. (operation pattern 3B), when the heating operation is stopped, the operations of the compressor 21, the pump 11 and the blower fan 26 are stopped, and the flow direction of the coolant is set to be the flow direction d (indicated by the arrow d in FIG. 5) by the thermostat 5 based on the coolant temperature. The refrigerant in the heat pump cycle 20B does not circulate, and the coolant flows so as to circulate only in the first coolant circuit 1. Heat of the coolant heated in the engine 2 is radiated in the radiator 3, and cooling of the coolant is continuously performed. In contrast, when the heating operation is started, although the coolant does not flow into the indoor heat exchanger 13 temporarily, the flow direction of the coolant is set to be the flow direction c (indicated by the arrow c in FIG. 5) by the thermostat 5 before the temperature of the coolant remained in the indoor heat exchanger 13 about 90° C. is lowered, and the circulating flow in the fourth coolant circuit 14 is started again. Heat of the coolant heated in the engine 2 is supplied to the indoor heat exchanger 13, and heats air to be sent into the vehicle compartment, and thereby heat is sent to the heater in the vehicle compartment.

Next, the control of the vehicle air conditioner in the heating operation will be described with reference to FIG. 6. A process of the second example shown in FIG. 6, which is similar to the process of the first example shown in FIG. 3, is designated by the same step number with that of the first example. As shown in FIG. 6, when the power source is applied to the control device 100, the control device 100 determines whether the heating operation is started at S10. When it is determined that the heating operation is started at S10, it is determined whether the coolant temperature is lower than the predetermined temperature T1 (55° C., for example) at S20.

When it is determined that the coolant temperature is lower than the predetermined temperature T1 at S20, it is further determined whether the coolant temperature is lower than a predetermined temperature TO (0° C., for example), which is set to be lower than the predetermined temperature T1, at S25. When it is determined that the coolant temperature is lower than the predetermined temperature T0 at S25, the operation similar to that of the above-described operation pattern 1B-2 is performed at S26. Then, returning to S10, the following processes are continuously performed. In this manner, when the coolant temperature is so low, heat of the outdoor air not the coolant is transferred to the refrigerant and the refrigerant is compressed by the compressor 21 to become a high pressure so that air to be sent into the vehicle compartment is heated in the indoor heat exchanger 13 via the high-pressure side heat exchanger. Thus, even when the coolant temperature is so low promptly after the starting of the engine operation, the heat of the outdoor air is transferred to the refrigerant to contribute to the heater and the heating capacity is further improved by the heat pump. Therefore, the feeling of heat at the starting of the heating operation can be improved.

When it is determined that the coolant temperature is equal to or higher than the predetermined temperature T0 at S25, the operation similar to that of the above-described operation pattern 1B-1 is performed at S30. Then, returning to S10, the following processes are continuously performed. In this manner, heat of the coolant is transferred to the refrigerant and the refrigerant is compressed by the compressor 21 to become a high pressure so that air to be sent into the vehicle compartment is heated in the indoor heat exchanger 13 via the high-pressure side heat exchanger. Thus, even when the coolant temperature is low, the heat of the coolant is transferred to the refrigerant to contribute to the heater and the heating capacity is further improved by the heat pump. Therefore, the heat radiated from the engine 2 can be effectively used for the heater, and the feeling of heat felt by the occupant can be improved.

When it is determined that the coolant temperature is equal to or higher than the predetermined temperature T1 at S20, the control device 100 further determines whether the coolant temperature is equal to or higher than the predetermined temperature T2 (90° C., for example) at S40. When it is determined that the coolant temperature is lower than the predetermined temperature T2 at S40, the operation similar to that of the above-described operation pattern 2B is performed at S43. Then, returning to S10, the following processes are continuously performed.

When it is determined that the coolant temperature is equal to or higher than the predetermined temperature T2 at S40, the operation similar to that of the above-described operation pattern 3B is performed at S41 and S42. Then, returning to S10, the following processes are continuously performed. The high-temperature coolant needs to be cooled. Thus, at S41, the heat of the coolant is radiated from the radiator 3 to cool the engine 2. Moreover, in the heating operation, the heat of the coolant needs to be used for the heater. Thus, at S42, the process for forming the circulating flow in the fourth coolant circuit 14 is performed before the temperature of the coolant remained in the indoor heat exchanger 13 about 90° C. is lowered, and thereby air is heated only by the heat of the coolant heated in the engine 2 to obtain the heating capacity.

According to the present embodiment, in the vehicle air conditioner, in the case where the heating capacity cannot be obtained by flowing the coolant through the inside of the indoor heat exchanger 13 in the heating operation, when the coolant temperature is lower than the predetermined temperature TO, the refrigerant in the heat pump cycle 20B flows into the outdoor heat exchanger 25 and the blower fan 26 is operated to blow the outdoor air to the outdoor heat exchanger 25. Further, the heat of the outdoor air is absorbed by the refrigerant and air is heated in the indoor heat exchanger 13 by using the heat of the refrigerant that has absorbed the heat of the outdoor air. When the coolant temperature is increased to equal to or higher than the predetermined temperature T0, the coolant flows through the first water-refrigerant heat exchanger 24 and the refrigerant in the heat pump cycle 20B flows into the first water-refrigerant heat exchanger 24.

Accordingly, when the sufficient heating capacity cannot be obtained from the coolant and much heat can be obtained by absorbing the heat of the outdoor air instead of the heat of the coolant, the heat of the outdoor air is transferred to the refrigerant in the outdoor heat exchanger 25 and the heat of the refrigerant that has absorbed the heat of the outdoor air is radiated in the second water-refrigerant heat exchanger 22 so that the heat is supplied to the air to be used for the heater. When sufficient heat can be obtained from the heat of the coolant, the coolant flows through the first water-refrigerant heat exchanger 24 and the heat of the coolant is absorbed by the refrigerant circulating in the heat pump cycle 20B by the heat pump. In addition, the heat radiated from the high pressure refrigerant in the second water-refrigerant heat exchanger 22 at the high-pressure side in the heat pump cycle 20B is used to heat the air. Therefore, the heating operation is performed using the heat of the outdoor air instead of the heat of the coolant when the coolant temperature is significantly low, and thereby lowering of the heater temperature at the starting of the heating operation in winter, for example, can be suppressed.

### Fourth Embodiment

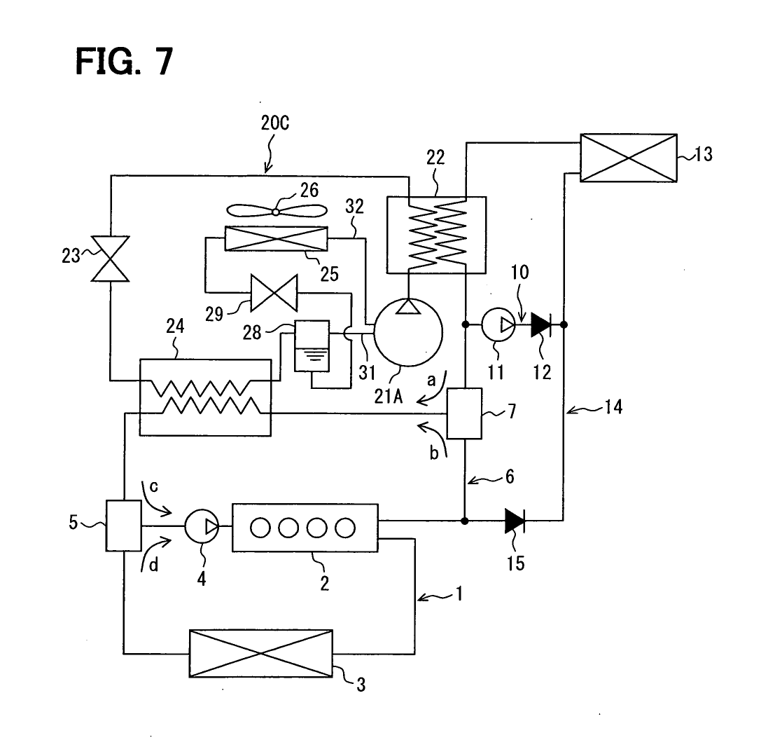

In a fourth embodiment, another example of the vehicle air conditioner of the first embodiment will be described with reference to FIG. 7. A component in FIG. 7, which is designated by the same reference numeral with the component in FIG. 1, is the same component with that of the first embodiment, and has the similar effect described in the first embodiment.

As shown in FIG. 7, a heat pump cycle 20C of a vehicle air conditioner of the present embodiment differs from the heat pump cycle 20 of the first embodiment in the following points. A compressor 21A has a gas injection port to which a gas-phase refrigerant is introduced. The heat pump cycle 20C has a gas-liquid separator 28, a gas injection pipe 31, a refrigerant pipe 32, an expansion valve 29, the outdoor heat exchanger 25 and the blower fan 26. The gas-liquid separator 28 separates a gas-phase and a liquid-phase of the refrigerant that has been heat-exchanged with the coolant in the first water-refrigerant heat exchanger 24. The gas injection pipe 31 introduces the gas-phase refrigerant separated in the gas-liquid separator 28 to the gas injection port. The expansion valve 29 as a second decompression device decompresses the liquid-phase refrigerant separated in the gas-liquid separator 28. The refrigerant decompressed by the expansion valve 29 flows through the inside of the outdoor heat exchanger 25 and heat is exchanged between the refrigerant and outdoor air. The blower fan 26 blows the outdoor air to the outdoor heat exchanger 25. As with the expansion valve 23, the expansion valve 29 may be a fixed type expansion valve or a flow-control type expansion valve.

The compressor 21A is a gas injection compressor, for example, a two-cylinder gas injection compressor. In the heat pump cycle 20C, the saturated gas-phase refrigerant separated in the gas-liquid separator 28 passes through the gas injection pipe 31 and is introduced to the compressor 21A as an intermediate pressure refrigerant from the gas injection port. The saturated liquid-phase refrigerant separated in the gas-liquid separator 28 flows down through the refrigerant pipe 32 and is further decompressed by the expansion valve 29. Then, the decompressed refrigerant is heated by the outdoor air in the outdoor heat exchanger 25 and is drawn into the compressor 21A as a low pressure refrigerant. In a cylinder of the compressor 21A, the intermediate pressure refrigerant introduced from the gas injection port is mixed with the low pressure refrigerant that is compressed to substantially intermediate pressure, and the both refrigerants are compressed to become high pressure and are discharged to the second water-refrigerant heat exchanger 22. Because the low pressure refrigerant flows into the outdoor heat exchanger 25 to be heat-exchanged with low temperature air, the heat exchange between fluids which have a slight temperature difference, is performed, and thereby the heat-exchange efficiency can be increased. Further, the gas injection pipe 31 may have a solenoid valve for controlling the injection amount of gas to be drawn into the compressor 21A. By controlling the solenoid valve, force for operating the compressor 21A can be controlled appropriately.

In the present embodiment, in addition to the function above-described in the first embodiment, the control device 100 performs calculations based on stored programs using the received air-conditioner environmental information, air-conditioner operating-condition information and vehicle environmental information to calculate the rotation frequency of the blower fan 26 (i.e., the amount of blown air), and thereby the operation of the blower fan 26 is controlled.

Hereinafter, the control of the vehicle air conditioner according to the present embodiment in the heating operation will be described. Operation patterns 1C, 2C, 3C described below correspond to the operation patterns 1, 2, 3, which are described based on the flow diagram of FIG. 3 in the first embodiment, respectively.

In the case where the coolant temperature is lower than 55° C. in the heating operation (operation pattern 1C), the operations of the compressor 21A, the pump 11 and the blower fan 26 are started by the control device 100, and the flow direction of the coolant is set to be the flow direction c (indicated by the arrow c in FIG. 7) by the thermostat 5 and the flow direction b (indicated by the arrow b in FIG. 7) by the thermostat 7 based on the coolant temperature. The refrigerant in the heat pump cycle 20C circulates, and the coolant flows so as to circulate in the second coolant circuit 6 and the third coolant circuit 10. The low pressure refrigerant that has been decompressed by the expansion valve 23 absorbs heat from the coolant in the first water-refrigerant heat exchanger 24, and then, the saturated gas-phase refrigerant separated in the gas-liquid separator 28 is drawn into the compressor 21A as the intermediate pressure refrigerant. The saturated liquid-phase refrigerant separated in the gas-liquid separator 28 is decompressed by the expansion valve 29 so that the pressure thereof is lowered. Then, the liquid-phase refrigerant is heated by the outdoor air in the outdoor heat exchanger 25 and is drawn into the compressor 21A as the low pressure refrigerant. The low pressure refrigerant flowing down through the refrigerant pipe 32 and the intermediate pressure refrigerant flowing down through the gas injection pipe 31 are compressed by the compressor 21A to become high pressure, and the mixed refrigerant heats the coolant circulating in the third coolant circuit 10 in the second water-refrigerant heat exchanger 22. The heated coolant heats air to be sent into the vehicle compartment in the indoor heat exchanger 13, and thereby heat is sent to the heater in the vehicle compartment.

In the case where the coolant temperature is equal to or higher than 55° C. and lower than 90° C. in the heating operation (operation pattern 2C), the operations of the compressor 21A, the pump 11 and the blower fan 26 are stopped, and the flow direction of the coolant is set to be the flow direction c (indicated by the arrow c in FIG. 7) by the thermostat 5 and the flow direction a (indicated by the arrow a in FIG. 7) by the thermostat 7 based on the coolant temperature. The refrigerant in the heat pump cycle 20C does not circulate, and the coolant flows so as to circulate only in the fourth coolant circuit 14. Heat of the coolant heated in the engine 2 is supplied to the indoor heat exchanger 13, and heats air to be sent into the vehicle compartment, and thereby heat is sent to the heater in the vehicle compartment.

In the case where the coolant temperature is equal to or higher than 90° C. (operation pattern 3C), when the heating operation is stopped, the operations of the compressor 21A, the pump 11 and the blower fan 26 are stopped, and the flow direction of the coolant is set to be the flow direction d (indicated by the arrow d in FIG. 7) by the thermostat 5 based on the coolant temperature. The refrigerant in the heat pump cycle 20C does not circulate, and the coolant flows so as to circulate only in the first coolant circuit 1. Heat of the coolant heated in the engine 2 is radiated in the radiator 3, and cooling of the coolant is continuously performed. In contrast, when the heating operation is started, although the coolant does not flow into the indoor heat exchanger 13 temporarily, the flow direction of the coolant is set to be the flow direction c (indicated by the arrow c in FIG. 7) by the thermostat 5 before the temperature of the coolant remained in the indoor heat exchanger 13 about 90° C. is lowered, and the circulating flow in the fourth coolant circuit 14 is started again. Heat of the coolant heated in the engine 2 is supplied to the indoor heat exchanger 13, and heats air to be sent into the vehicle compartment, and thereby heat is sent to the heater in the vehicle compartment.

According to the present embodiment, the saturated gas as the intermediate pressure refrigerant is drawn into the compressor 21A though the gas injection pipe 31, and the saturated liquid is further decompressed by the expansion valve 29 to be drawn into the compressor 21A as the low pressure refrigerant. Thus, the heat pump cycle 20C that is highly effective in decreasing the force for operating the compressor 21A can be configured. Further, the saturated liquid that is decompressed by the expansion valve 29 absorbs heat from the outdoor air in the outdoor heat exchanger 25, and thereby heat can be exchanged between the low pressure refrigerant and the low temperature air. Thus, the heat-exchange efficiency in the outdoor heat exchanger 25 can be increased. Therefore, the vehicle air conditioner of the present embodiment can improve the power saving of the force for operating the heater and provide the, high-efficiency heat pump cycle 20C.

### Fifth Embodiment

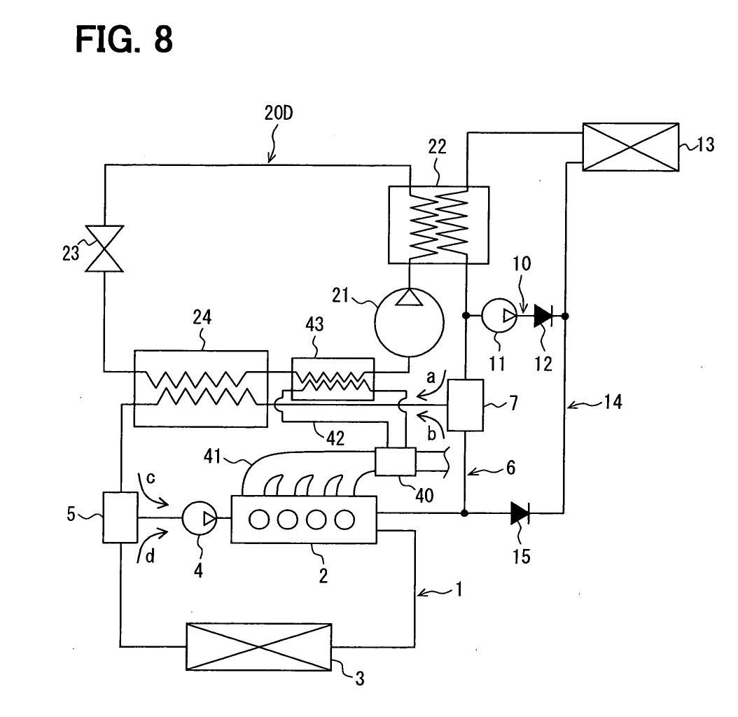

In a fifth embodiment, another example of the vehicle air conditioner of the first embodiment will be described with reference to FIG. 8. A component in FIG. 8, which is designated by the same reference numeral with the component in FIG. 1, is the same component with that of the first embodiment, and has the similar effect described in the first embodiment.

As shown in FIG. 8, a heat pump cycle 20D of a vehicle air conditioner of the present embodiment differs from the heat pump cycle 20 of the first embodiment in that the heat pump cycle 20D has an exhaust-heat recovery device 40 and a heat exchanger 43 for exhaust heat (hereinafter referred to as an exhaust-heat heat exchanger 43). In the exhaust-heat recovery device 40, a heat exchange medium (water, for example) recovers heat of exhaust gas flowing out of the engine 2 and down through an exhaust pipe 41. In the exhaust-heat heat exchanger 43, heat is exchanged between the heat exchange medium and a refrigerant circulating in the heat pump cycle 20D. An operating fluid included in the inside of the exhaust-heat recovery device 40 is evaporated by the exhaust gas so that the exhaust-heat recovery device 40 absorbs evaporative latent heat.

The exhaust-heat recovery device 40 absorbs heat from the exhaust gas by a heat-pipe type boiling heat transfer. The exhaust-heat recovery device 40 includes an evaporation portion and a condensation portion communicating with the evaporation portion. In the evaporation portion, the operating fluid included in the inside of a closed-loop circuit is heated by the exhaust gas to be evaporated. In the condensation portion, the operating fluid that is evaporated in the evaporation portion is condensed. The exhaust-heat heat exchanger 43 includes a refrigerant passage in a part of a low-pressure side passage of the heat pump cycle 20D at a draw side of the compressor 21 and a passage of a part of a circuit 42, in which the heat exchange medium that has absorbed the heat of the exhaust gas in the condensation portion circulates. The exhaust-heat heat exchanger 43 is configured such that heat is exchanged between fluids flowing in the refrigerant passage and the passage of the part of the circuit 42.

In the condensation portion of the exhaust-heat recovery device 40, the gas-phase operating fluid evaporated in the evaporation portion is condensed, and the condensation heat is radiated to be recovered by the heat exchange medium. The heat exchange medium circulates in the circuit 42, and heat thereof is radiated to the refrigerant in a passage of the exhaust-heat heat exchanger 43 (i.e., the passage of the part of the circuit 42) so that the heat recovered from the exhaust gas is transferred to the refrigerant. The recovered heat from the exhaust gas, which is transferred to the refrigerant, is drawn into and compressed by the compressor 21 so that the heat is absorbed in the high pressure refrigerant. The high pressure refrigerant heats the coolant circulating in the third coolant circuit 10 in the second water-refrigerant heat exchanger 22. Further, the circuit 42 may have a solenoid valve for controlling the flow mount of the heat exchange medium to be flowed into the exhaust-heat heat exchanger 43. By controlling the solenoid valve, the amount of recovered heat from the exhaust gas to be absorbed by the refrigerant in the heat pump cycle 20D can be controlled appropriately in accordance with the air-conditioner environmental information, the air-conditioner operating-condition information and the vehicle environmental information.

Hereinafter, the control of the vehicle air conditioner according to the present embodiment in the heating operation will be described. Operation patterns 1D, 2D, 3D described below correspond to the operation patterns 1, 2, 3, which are described based on the flow diagram of FIG. 3 in the first embodiment, respectively. In the case where the coolant temperature is lower than 55° C. in the heating operation (operation pattern 1D), the operations of the compressor 21 and the pump 11 are started by the control device 100, and the flow direction of the coolant is set to be the flow direction c (indicated by the arrow c in FIG. 8) by the thermostat 5 and the flow direction b (indicated by the arrow b in FIG. 8) by the thermostat 7 based on the coolant temperature. The refrigerant in the heat pump cycle 20D circulates, and the coolant flows so as to circulate in the second coolant circuit 6 and the third coolant circuit 10. The low pressure refrigerant that has been decompressed by the expansion valve 23 is heated by the coolant in the first water-refrigerant heat exchanger 24 and is further heated by the heat exchange medium, which has absorbed the heat of the exhaust gas, in the exhaust-heat heat exchanger 43. Then, the refrigerant is drawn into and compressed by the compressor 21 to become high pressure, and the compressed refrigerant heats the coolant circulating in the third coolant circuit 10 in the second water-refrigerant heat exchanger 22. The heated coolant heats, air to be sent into the vehicle compartment in the indoor heat exchanger 13, and thereby heat is sent to the heater in the vehicle compartment.

In the case where the coolant temperature is equal to or higher than 55° C. and lower than 90° C. in the heating operation (operation pattern 2D), the operations of the compressor 21 and the pump 11 are stopped, and the flow direction of the coolant is set to be the flow direction c (indicated by the arrow c in FIG. 8) by the thermostat 5 and the flow direction a (indicated by the arrow a in FIG. 8) by the thermostat 7 based on the coolant temperature. The refrigerant in the heat pump cycle 20D does not circulate, and the coolant flows so as to circulate only in the fourth coolant circuit 14. Heat of the coolant heated in the engine 2 is supplied to the indoor heat exchanger 13, and heats air to be sent into the vehicle compartment, and thereby heat is sent to the heater in the vehicle compartment.

In the case where the coolant temperature is equal to or higher than 90° C. (operation pattern 3D), when the heating operation is stopped, the operations of the compressor 21 and the pump 11 are stopped, and the flow direction of the coolant is set to be the flow direction d (indicated by the arrow d in FIG. 8) by the thermostat 5 based on the coolant temperature. The refrigerant in the heat pump cycle 20D does not circulate, and the coolant flows so as to circulate only in the first coolant circuit, 1. Heat of the coolant heated in the engine 2 is radiated in the radiator 3, and cooling of the coolant is continuously performed. In contrast, when the heating operation is started, although the coolant does not flow into the indoor heat exchanger 13 temporarily, the flow direction of the coolant is set to be the flow direction c (indicated by the arrow c in FIG. 8) by the thermostat 5 before the temperature of the coolant remained in the indoor heat exchanger 13 about 90° C. is lowered, and the circulating flow in the fourth coolant circuit 14 is started again. Heat of the coolant heated in the engine 2 is supplied to the indoor heat exchanger 13, and heats air to be sent into the vehicle compartment, and thereby heat is sent to the heater in the vehicle compartment.

According to the vehicle air conditioner of the present embodiment, when the heating capacity cannot be obtained by flowing the coolant through the inside of the indoor heat exchanger 13 in the heating operation, the refrigerant in the heat pump cycle 20D circulates, and the heat of the coolant is absorbed by the refrigerant in the first water-refrigerant heat exchanger 24, and further, the heat of the exhaust gas is absorbed by the refrigerant in the exhaust-heat heat exchanger 43.

Accordingly, when the sufficient heating capacity cannot be obtained from the coolant (i.e., in the operation pattern 1D), the coolant flows through the first water-refrigerant heat exchanger 24 and the heat of the coolant is absorbed by the refrigerant circulating in the heat pump cycle 20D by the heat pump so that the heat that has been absorbed by the refrigerant is radiated in the indoor heat exchanger 13 to heat air. Further, the recovered heat from the exhaust gas, which is recovered in the exhaust-heat recovery device 40, is transferred to the refrigerant in the exhaust-heat heat exchanger 43, and the heat of the refrigerant that has absorbed the heat of the exhaust gas is radiated to the coolant circulating in the third coolant circuit 10 in the second water-refrigerant heat exchanger 22 (the high-pressure side heat exchanger) so that the amount of heat to the air for the heater is increased in the indoor heat exchanger 13. In addition to the air for the heater that has absorbed heat from the coolant and the refrigerant compressed by the compressor 21, the heat of the exhaust gas, which is influenced by the exhaust heat from the engine 2, is absorbed in the refrigerant, and thereby the heating capacity can be further improved.

### Sixth Embodiment

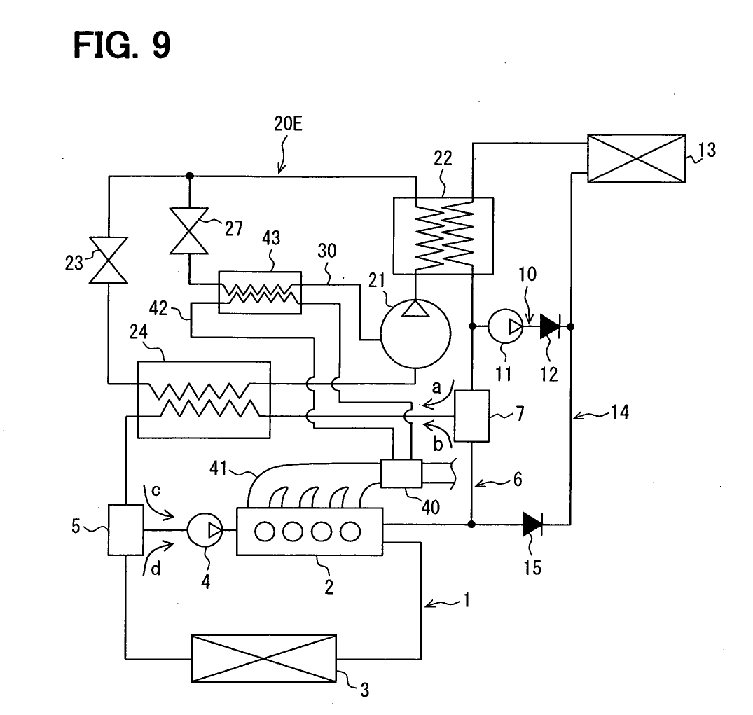

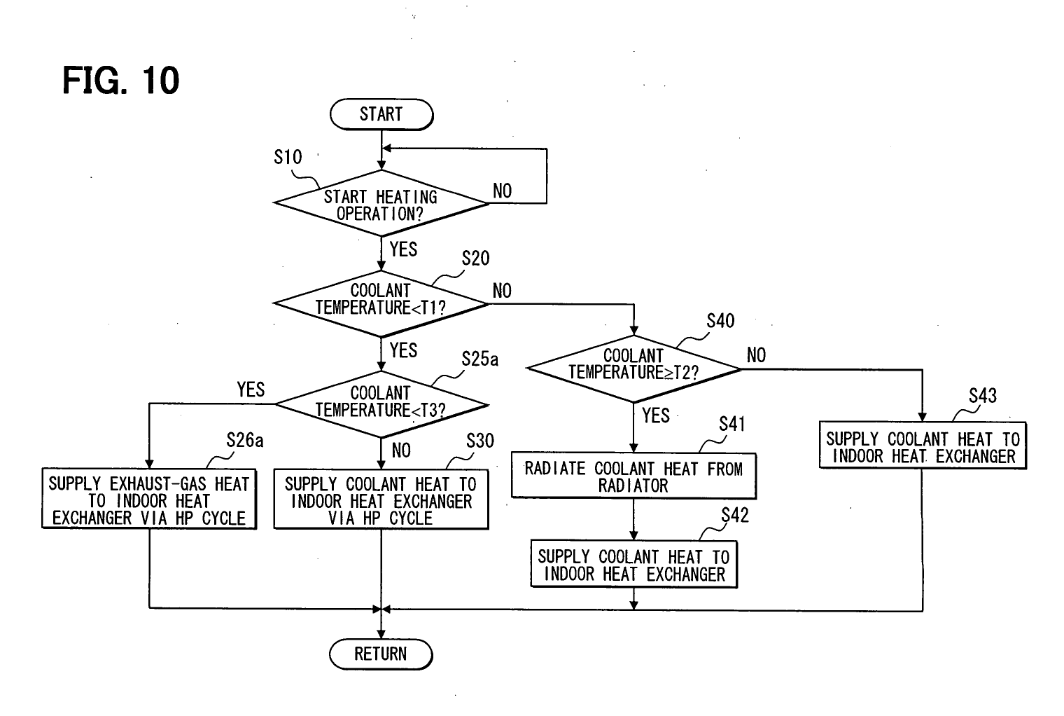

In a sixth embodiment, another example of the vehicle air conditioner of the first embodiment will be described with reference to FIGS. 9 and 10. A component or a step in FIGS. 9 and 10, which is designated by the same reference numeral with the component or the step in FIGS. 1 and 3, is the same component or the step with that of the first embodiment, and has the similar effect described in the first embodiment.

As shown in FIG. 9, a heat pump cycle 20E of a vehicle air conditioner of the present embodiment differs from the heat pump cycle 20 of the first embodiment in the following points. The heat pump cycle 20E has the refrigerant passage that is branched into the first refrigerant passage and the second refrigerant passage 30 at the discharge side of the second water-refrigerant heat exchanger 22. In the first refrigerant passage, the expansion valve 23 and the first water-refrigerant heat exchanger 24 are arranged in this order in the downstream direction. In the second refrigerant passage 30, the expansion valve 27 and the exhaust-heat heat exchanger 43 are arranged in this order in the downstream direction. Similar to the fifth embodiment, the heat exchange medium circulating in the circuit 42 recovers the heat of the exhaust gas in the exhaust-heat recovery device 40, and the heat exchange medium heats the refrigerant in the exhaust-heat heat exchanger 43.

The exhaust-heat heat exchanger 43 is arranged in parallel with the first water-refrigerant heat exchanger 24 such that the refrigerant discharged from the compressor 21 flows into at least one of the first water-refrigerant heat exchanger 24 and the exhaust-heat heat exchanger 43. The expansion valve 27 is a decompression device that decompresses the refrigerant flowing out of the second water-refrigerant heat exchanger 22 and into the second refrigerant passage 30, and causes the refrigerant flowing into the exhaust-heat heat exchanger 43 to be a low pressure refrigerant. Each of the expansion valves 23, 27 of the present embodiment is a flow-control type expansion valve, and the opening degree thereof is controlled by the control device 100.

In the present embodiment, in addition to the function above-described in the first embodiment, the control device 100 performs calculations based on stored programs using the received air-conditioner environmental information, air-conditioner operating-condition information and vehicle environmental information to calculate the opening degrees of the expansion valves 23, 27, and thereby the operations of the expansion valves 23, 27 are controlled.

Hereinafter, the control of the vehicle air conditioner according to the present embodiment in the heating operation will be described.

In the case where the coolant temperature is lower than 55° C. in the heating operation (operation pattern 1E), for example, when the coolant temperature is equal to or higher than 30° C. and lower than 55° C., the operations of the compressor 21 and the pump 11 are started by the control device 100, the expansion valve 27 is controlled such that the opening degree thereof is zero, that is, the expansion valve 27 is totally closed, and the expansion valve 23 is controlled to be in an open state. Further, the flow direction of the coolant is set to be the flow direction c (indicated by the arrow c in FIG. 9) by the thermostat 5 and the flow direction b (indicated by the arrow b in FIG. 9) by the thermostat 7 based on the coolant temperature. The refrigerant in the heat pump cycle 20E circulates through the compressor 21, the second water-refrigerant heat exchanger 22, the expansion valve 23, the first water-refrigerant heat exchanger 24 and the compressor 21 in this order, and the coolant flows so as to circulate in the second coolant circuit 6 and the third coolant circuit 10. The low pressure refrigerant that has been decompressed by the expansion valve 23 is heated by the coolant in the first water-refrigerant heat exchanger 24. Then, the refrigerant is drawn into and compressed by the compressor 21 to become high pressure, and the compressed refrigerant heats the coolant circulating in the third coolant circuit 10 in the second water-refrigerant heat exchanger 22. The heated coolant heats air to be sent into the vehicle compartment in the indoor heat exchanger 13, and thereby heat is sent to the heater in the vehicle compartment (hereinafter referred to as operation pattern 1E-1).

For example, in operation pattern 1E, when the coolant temperature is lower than 30° C., it is determined that the amount of heat that can be absorbed from the recovered heat from the exhaust gas is more than that from the coolant. The operations of the compressor 21 and the pump 11 are started by the control device 100, the expansion valve 23 is controlled such that the opening degree thereof is zero, that is, the expansion valve 23 is totally closed, and the expansion valve 27 is controlled to be in an open state. Further, the flow direction of the coolant is set to be the flow direction c (indicated by the arrow c in FIG. 9) by the thermostat 5 and the flow direction b (indicated by the arrow b in FIG. 9) by the thermostat 7 based on the coolant temperature. The refrigerant in the heat pump cycle 20E circulates through the compressor 21, the second water-refrigerant heat exchanger 22, the expansion valve 27, the exhaust-heat heat exchanger 43 and the compressor 21 in this order, and the coolant flows so as to circulate in the second coolant circuit 6 and the third coolant circuit 10. The low pressure refrigerant that has been decompressed by the expansion valve 27 is heated by the recovered heat from the exhaust gas in the exhaust-heat heat exchanger 43. Then, the refrigerant is drawn into and compressed by the compressor 21 to become high pressure, and the compressed refrigerant heats the coolant circulating in the third coolant circuit 10 in the second water-refrigerant heat exchanger 22 (hereinafter referred to as operation pattern 1E-2).

In the case where the coolant temperature is equal to or higher than 55° C. and lower than 90° C. in the heating operation (operation pattern 2E), the operations of the compressor 21 and the pump 11 are stopped, and the flow direction of the coolant is set to be the flow direction c (indicated by the arrow c in FIG. 9) by the thermostat 5 and the flow direction a (indicated by the arrow a in FIG. 9) by the thermostat 7 based on the coolant temperature. The refrigerant in the heat pump cycle 20E does not circulate, and the coolant flows so as to circulate only in the fourth coolant circuit 14. Heat of the coolant heated in the engine 2 is supplied to the indoor heat exchanger 13, and heats air to be sent into the vehicle compartment, and thereby heat is sent to the heater in the vehicle compartment.

In the case where the coolant temperature is equal to or higher than 90° C. (operation pattern 3E), when the heating operation is stopped, the operations of the compressor 21 and the pump 11 are stopped, and the flow direction of the coolant is set to be the flow direction d (indicated by the arrow d in FIG. 9) by the thermostat 5 based on the coolant temperature. The refrigerant in the heat pump cycle 20E does not circulate, and the coolant flows so as to circulate only in the first coolant circuit 1. Heat of the coolant heated in the engine 2 is radiated in the radiator 3, and cooling of the coolant is continuously performed. In contrast, when the heating operation is started, although the coolant does not flow into the indoor heat exchanger 13 temporarily, the flow direction of the coolant is set to, be the flow direction c (indicated by the arrow c in FIG. 9) by the thermostat 5 before the temperature of the coolant remained in the indoor heat exchanger 13 about 90° C. is lowered, and the circulating flow in the fourth coolant circuit 14 is started again. Heat of the coolant heated in the engine 2 is supplied to the indoor heat exchanger 13, and heats air to be sent into the vehicle compartment, and thereby heat is sent to the heater in the vehicle compartment.

Next, the control of the vehicle air conditioner in the heating operation will be described with reference to FIG. 10. A process of the third example shown in FIG. 10, which is similar to the process of the first example shown in FIG. 3, is designated by the same step number with that of the first example. As shown in FIG. 10, when the power source is applied to the control device 100, the control device 100 determines whether the heating operation is started at S10. When it is determined that the heating operation is started at S10, it is determined whether the coolant temperature is lower than the predetermined temperature T1 (55° C., for example) at S20.

When it is determined that the coolant temperature is lower than the predetermined temperature T1 at S20, it is further determined whether the coolant temperature is lower than a predetermined temperature T3 (30° C., for example), which is set to be lower than the predetermined temperature T1, at S25a. When it is determined that the coolant temperature is lower than the predetermined temperature T3 at S25a, the operation similar to that of the above-described operation pattern 1E-2 is performed at S26a. Then, returning to S10, the following processes are continuously performed. In this manner, when the coolant temperature is low, the heat of the exhaust gas, which is influenced by the exhaust heat from the engine 2 and increases the temperature of the refrigerant more rapidly than the coolant, is transferred to the refrigerant and the refrigerant is compressed by the compressor 21 to become a high pressure so that air to be sent into the vehicle compartment is heated in the indoor heat exchanger 13 via the high-pressure side heat exchanger. Thus, even when the coolant temperature is so low promptly after the starting of the engine operation, for example, the heat of the exhaust gas is transferred to the refrigerant to contribute to the heater and the heating capacity is further improved by the heat pump. Therefore, the feeling of heat at the starting of the heating operation can be improved.

When it is determined that the coolant temperature is equal to or higher than the predetermined temperature T3 at S25a, the operation similar to that of the above-described operation pattern 1E-1 is performed at S30. Then, returning to S10, the following processes are continuously performed. In this manner, heat of the coolant is transferred to the refrigerant and the refrigerant is compressed by the compressor 21 to become a high pressure so that air to be sent into the vehicle compartment is heated in the indoor heat exchanger 13 via the high-pressure side heat exchanger. Thus, even when the coolant temperature is low, the heat of the coolant is transferred to the refrigerant to contribute to the heater and the heating capacity is further improved by the heat pump. Therefore, the heat radiated from the engine 2 can be effectively used for the heater, and the feeling of heat felt by the occupant can be improved.

When it is determined that the coolant temperature is equal to or higher than the predetermined temperature T1 at S20, the control device 100 further determines whether the coolant temperature is equal to or higher than the predetermined temperature T2 (90° C., for example) at S40. When it is determined that the coolant temperature is lower than the predetermined temperature T2 at S40, the operation similar to that of the above-described operation pattern 2E is performed at S43. Then, returning to S10, the following processes are continuously performed.

When it is determined that the coolant temperature is equal to or higher than the predetermined temperature T2 at S40, the operation similar to that of the above-described operation pattern 3E is performed at S41 and S42. Then, returning to S10, the following processes are continuously performed. The high-temperature coolant needs to be cooled. Thus, at S41, the heat of the coolant is radiated from the radiator 3 to cool the engine 2. Moreover, in the heating operation, the heat of the coolant needs to be used for the heater. Thus, at S42, the process for forming the circulating flow in the fourth coolant circuit 14 is performed before the temperature of the coolant remained in the indoor heat exchanger 13 about 90° C. is lowered, and thereby air is heated only by the heat of the coolant heated in the engine 2 to obtain the heating capacity.

According to the present embodiment, in the vehicle air conditioner, in the case where the heating capacity cannot be obtained by flowing the coolant through the inside of the indoor heat exchanger 13 in the heating operation, when the coolant temperature is lower than the predetermined temperature T3, the refrigerant in the heat pump cycle 20E flows into the exhaust-heat heat exchanger 43 and the heat of the exhaust gas is absorbed by the refrigerant. Further, air is heated in the indoor heat exchanger 13 by using the heat of the refrigerant that has absorbed the heat of the exhaust gas. When the coolant temperature is increased to equal to or higher than the predetermined temperature T3, the coolant flows through the first water-refrigerant heat exchanger 24 and the refrigerant in the heat pump cycle 20E flows into the first water-refrigerant heat exchanger 24.

Accordingly, when the sufficient heating capacity cannot be obtained from the coolant and much heat can be obtained by absorbing the heat of the exhaust gas instead of the heat of the coolant, the heat of the exhaust gas is transferred to the refrigerant in the exhaust-heat heat exchanger 43 and the heat of the refrigerant that has absorbed the heat of the exhaust gas is radiated in the second water-refrigerant heat exchanger 22 so that the heat is supplied to the air to be used for the heater. When sufficient heat can be obtained from the heat of the coolant, the coolant flows through the first water-refrigerant heat exchanger 24 and the heat of the coolant is absorbed by the refrigerant circulating in the heat pump cycle 20E by the heat pump. In addition, the heat radiated from the high pressure refrigerant in the second water-refrigerant heat exchanger 22 at the high-pressure side in the heat pump cycle 20E is used to heat the air. Therefore, the heating operation is performed using the heat of the exhaust gas, whose temperature increases rapidly, instead of the heat of the coolant when the coolant temperature is significantly low, and thereby lowering of the heater temperature at the starting of the heating operation in winter, for example, can be suppressed.

### Seventh Embodiment

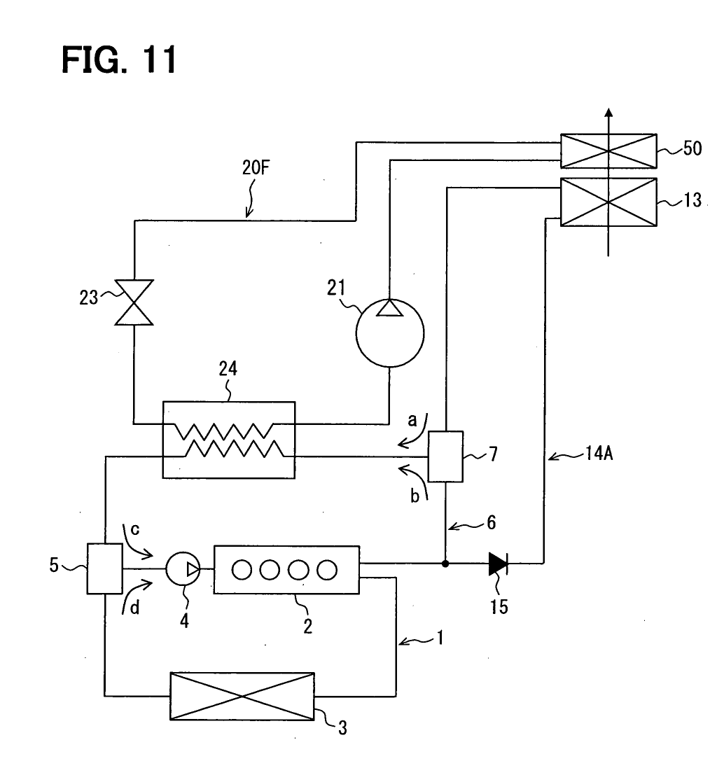

In a seventh embodiment, another example of the vehicle air conditioner of the first embodiment will be described with reference to FIG. 11. A component in FIG. 11, which is designated by the same reference numeral with the component in FIG. 1, is the same component with that of the first embodiment, and has the similar effect described in the first embodiment.

As shown in FIG. 11, a heat pump cycle 20F of a vehicle air conditioner of the present embodiment differs from the heat pump cycle 20 of the first embodiment in the following points. The heat pump cycle 20F has a radiator 50 as a high-pressure side heat exchanger into which the high pressure refrigerant discharged from the compressor 21 flows, and the radiator 50 is arranged downstream of the air flow of the indoor heat exchanger 13. The radiator 50 is also an indoor heat exchanger that has a refrigerant passage and an air passage adjacent to the refrigerant passage. The radiator 50 is configured such that the refrigerant circulating in the heat pump cycle 20F flows through the refrigerant passage, and outdoor air to be heat-exchanged with the refrigerant flows outside the refrigerant passage so that air to be blown into the vehicle compartment can be heated.

The coolant circuit contributing to the heating operation of the vehicle air conditioner is constructed of the first coolant circuit 1, the second coolant circuit 6, and a fourth coolant circuit 14A. Because the vehicle air conditioner of the present embodiment does not have a heat exchanger corresponding to the second water-refrigerant heat exchanger 22, the coolant circuit does not include the third coolant circuit 10. Accordingly, the vehicle air conditioner of the present embodiment does not include the pump 11 and the check valve 12.

Hereinafter, the control of the vehicle air conditioner according to the present embodiment in the heating operation will be described. Operation patterns 1F, 2F, 3F described below correspond to the operation patterns 1, 2, 3, which are described based on the flow diagram of FIG. 3 in the first embodiment, respectively.

In the case where the coolant temperature is lower than 55° C. in the heating operation (operation pattern 1F), the operation of the compressor 21 is started by the control device 100, and the flow direction of the coolant is set to be the flow direction c (indicated by the arrow c in FIG. 11) by the thermostat 5 and the flow direction b (indicated by the arrow b in FIG. 11) by the thermostat 7 based on the coolant temperature. The refrigerant in the heat pump cycle 20F circulates, and the coolant flows so as to circulate in the second coolant circuit 6. The low pressure refrigerant that has been decompressed by the expansion valve 23 is heated by the coolant in the first water-refrigerant heat exchanger 24. Further, the refrigerant is drawn into and compressed by the compressor 21 to become high pressure, and heats the air to be blown into the vehicle compartment in the radiator 50, and thereby heat is sent to the heater in the vehicle compartment.

In the case where the coolant temperature is equal to or higher than 55° C. and lower than 90° C. in the heating operation (operation pattern 2F), the operation of the compressor 21 is stopped, and the flow direction of the coolant is set to be the flow direction c (indicated by the arrow c in FIG. 11) by the thermostat 5 and the flow direction a (indicated by the arrow a in FIG. 11) by the thermostat 7 based on the coolant temperature. The refrigerant in the heat pump cycle 20F does not circulate, and the coolant flows so as to circulate only in the fourth coolant circuit 14A. Heat of the coolant heated in the engine 2 is supplied to the indoor heat exchanger 13, and heats air to be sent into the vehicle compartment, and thereby heat is sent to the heater in the vehicle compartment.

In the case where the coolant temperature is equal to or higher than 90° C. (operation pattern 3F), when the heating operation is stopped, the operation of the compressor 21 is stopped, and the flow direction of the coolant is set to be the flow direction d (indicated by the arrow d in FIG. 11) by the thermostat 5 based on the coolant temperature. The refrigerant in the heat pump cycle 20F does not circulate, and the coolant flows so as to circulate only in the first coolant circuit 1. Heat of the coolant heated in the engine 2 is radiated in the radiator 3, and cooling of the coolant is continuously performed. In contrast, when the heating operation is started, although the coolant does not flow into the indoor heat exchanger 13 temporarily, the flow direction of the coolant is set to be the flow direction c (indicated by the arrow c in FIG. 11) by the thermostat 5 before the temperature of the coolant remained in the indoor heat exchanger 13 about 90° C. is lowered, and the circulating flow in the fourth coolant circuit 14A is started again. Heat of the coolant heated in the engine 2 is supplied to the indoor heat exchanger 13, and heats air to be sent into the vehicle compartment, and thereby heat is sent to the heater in the vehicle compartment.

According to the present embodiment, the radiator 50 that cools the high pressure, refrigerant compressed by the compressor 21 is arranged in the air passage communicating with the vehicle compartment as well as the indoor heat exchanger 13, and the air is directly heated by the radiator 50. Therefore, the vehicle air conditioner, in which the force for operating the heater can be saved and the energy efficiency of the entire vehicle and the fuel consumption can be improved, can be provided. Further, the configuration of the coolant circuit contributing to the heating operation can be simplified, and the number of components and devices which need to be controlled can be reduced.

### Other Embodiments

Although the preferable embodiments of the present invention are described above, the present invention is not limited thereto and can be modified variously without departing from the spirit and scope of the invention.

The third and sixth embodiments have the configuration that the refrigerant passage 30 is directly connected to the compressor 21. However, these embodiments are not limited to the configuration, and may have a configuration that the refrigerant passage 30 is joined to the refrigerant passage between the first water-refrigerant heat exchanger 24 and the compressor 21. In this case, the refrigerant flowing down through the refrigerant passage 30 and the refrigerant flowing out of the first water-refrigerant heat exchanger 24 are mixed at the upstream side of the compressor 21 to be a uniform pressure, and then the mixed refrigerant is drawn into the compressor 21.

The vehicle air conditioners of the above-described embodiments can be applied to a vehicle including a gasoline internal-combustion engine, a diesel internal-combustion engine or the like, a hybrid vehicle and an electric vehicle.

Other than carbon dioxide, R404A, a fluorocarbon refrigerant, a hydrocarbon refrigerant and the like can be used as the refrigerant in the above-described embodiments.

Further, the second water-refrigerant heat exchanger 22 as the high-pressure side heat exchanger of the heat pump cycle may be arranged in front of the radiator 3.

While the invention has been described with reference to preferred embodiments thereof, it is to be understood that the invention is not limited to the preferred embodiments and constructions. The invention is intended to cover various modification and equivalent, arrangements. In addition, while the various combinations and configurations, which are preferred, other combinations and configurations, including more, less or only a single element, are also within the spirit and scope of the invention.

What is claimed is:

1. An air conditioner for a vehicle, comprising:
a coolant circuit configured such that a coolant for cooling an engine for driving the vehicle circulates therein, the coolant circuit being connected to the engine;
a heat pump cycle configured to condition air in a vehicle compartment by controlling a state of a refrigerant circulating therein, the heat pump cycle including
a compressor configured to draw and discharge the refrigerant,
a high-pressure side heat exchanger configured to cool the refrigerant discharged from the compressor,
a first decompression device configured to decompress the refrigerant flowing out of the high-pressure side heat exchanger, and
a first water-refrigerant heat exchanger, through which the coolant in the coolant circuit and the refrigerant decompressed by the first decompression device are capable of flowing, configured such that heat is exchanged between the decompressed refrigerant and the coolant so that heat of the coolant is-absorbed by the refrigerant; and
a heater located in the vehicle compartment to heat the air by using heat of at least one of the coolant and the refrigerant, wherein
the coolant circuit and the heat pump cycle are configured to provide an indoor heat exchanger, the indoor heat exchanger being configured such that heat is exchanged between air to be supplied to the vehicle compartment via an outside thereof and the refrigerant or the coolant flowing through an inside thereof,
the heat pump cycle is configured such that the coolant flows directly in the inside of the indoor heat exchanger to heat the air to be supplied to the vehicle compartment when heating capacity is obtained by flowing the coolant through the inside of the indoor heat exchanger in a heating operation for heating the vehicle compartment, and
the heat pump cycle is configured such that the coolant flows through the first water-refrigerant heat exchanger, the refrigerant in the heat pump cycle circulates, the heat of the coolant is absorbed by the refrigerant in the first water-refrigerant heat exchanger, and the air to be supplied to the vehicle compartment is heated in the indoor heat exchanger by using heat of the refrigerant that has absorbed the heat of the coolant when the heating capacity is not obtained by flowing the coolant through the inside of the indoor heat exchanger in the heating operation.

2. The air conditioner according to claim 1, wherein
the high-pressure side heat exchanger is a second water-refrigerant heat exchanger, through which the refrigerant discharged from the compressor and the coolant flowing through the inside of the indoor heat exchanger are capable of flowing, configured such that heat is exchanged between the refrigerant and the coolant so that the heat of the refrigerant is absorbed by the coolant,
the coolant circuit includes first to fourth coolant circuits,
a radiator that radiates the heat of the coolant to outside is arranged in the first coolant circuit and the coolant circulates through the radiator and the engine in the first coolant circuit,
the coolant circulates through the first water-refrigerant heat exchanger and the engine in the second coolant circuit,
the coolant circulates through the second water-refrigerant heat exchanger and the inside of the indoor heat exchanger in the third coolant circuit,
the coolant circulates through the first water-refrigerant heat exchanger, the engine, the inside of the indoor heat exchanger and the second water-refrigerant heat exchanger in the fourth coolant circuit,
the heat pump cycle is configured such that circulating of the refrigerant in the heat pump cycle is stopped and the coolant circulates in the fourth coolant circuit when the heating capacity is obtained by flowing the coolant through the inside of the indoor heat exchanger in the heating operation, and
the heat pump cycle is configured such that the refrigerant circulates in the heat pump cycle and the coolant circulates in the second coolant circuit and the third coolant circuit when the heating capacity is not obtained by flowing the coolant through the inside of the indoor heat exchanger in the heating operation.

3. The air conditioner according to claim 2, further comprising:
an outdoor heat exchanger configured such that the refrigerant circulating in the heat pump cycle flows through an inside thereof and heat is exchanged between the refrigerant and outdoor air; and
a blower fan configured to blow the outdoor air to the outdoor heat exchanger, wherein
the outdoor heat exchanger is arranged in parallel with the first water-refrigerant heat exchanger such that the refrigerant discharged from the compressor flows into at least one of the first water-refrigerant heat exchanger and the outdoor heat exchanger,
the heat pump cycle is configured such that the refrigerant in the heat pump cycle flows into the outdoor heat exchanger, the blower fan is operated to blow the outdoor air to the outdoor heat exchanger, heat of the outdoor air is absorbed by the refrigerant and the air to be supplied to the vehicle compartment is heated in the indoor heat exchanger by using the heat of the refrigerant that has absorbed the heat of the outdoor air when the heating capacity is not obtained by flowing the coolant through the inside of the indoor heat exchanger, and when a coolant temperature is lower than a predetermined temperature in the heating operation, and
the heat pump cycle is configured such that the coolant flows through the first water-refrigerant heat exchanger and the refrigerant in the heat pump cycle flows into the first water-refrigerant heat exchanger when the heating capacity is not obtained by flowing the coolant through the inside of the indoor heat exchanger, and when the coolant temperature is increased to equal to or higher than the predetermined temperature in the heating operation.

4. The air conditioner according to claim 2, further comprising:
an outdoor heat exchanger configured such that the refrigerant decompressed by the first decompression device flows through an inside thereof and heat is exchanged between the refrigerant and outdoor air; and
a blower fan configured to blow the outdoor air to the outdoor heat exchanger, wherein
the heat pump cycle is configured such that the refrigerant in the heat pump cycle circulates, the blower fan is operated to blow the outdoor air to the outdoor heat exchanger and the coolant flows into the first water-refrigerant heat exchanger when the heating capacity is not obtained by flowing the coolant through the inside of the indoor heat exchanger in the heating operation.

5. The air conditioner according to claim 2, further comprising:
a gas injection port in the compressor, the gas injection port being configured such that a gas-phase refrigerant is introduced thereto;
a gas-liquid separator configured to separate a gas-phase and a liquid-phase of the refrigerant heat-exchanged with the coolant in the first water-refrigerant heat exchanger;
a gas injection pipe configured to introduce the gas-phase refrigerant separated in the gas-liquid separator to the gas injection port;
a second decompression device configured to decompress the liquid-phase refrigerant separated in the gas-liquid separator;
an outdoor heat exchanger configured such that the refrigerant decompressed by the second decompression device flows through an inside thereof and heat is exchanged between the refrigerant and outdoor air; and
a blower fan configured to blow the outdoor air to the outdoor heat exchanger.

6. The air conditioner according to claim 2, further comprising:
an exhaust-heat recovery device configured such that a heat exchange medium thereof recovers heat of exhaust gas from the engine; and
an exhaust-heat heat exchanger configured such that heat is exchanged between the heat exchange medium and the refrigerant circulating in the heat pump cycle, wherein
the heat pump cycle is configured such that the refrigerant in the heat pump cycle circulates, the heat of the coolant is absorbed by the refrigerant in the first water-refrigerant heat exchanger, and the heat of the exhaust gas is absorbed by the refrigerant in the exhaust-heat heat exchanger when the heating capacity is not obtained by flowing the coolant through the inside of the indoor heat exchanger in the heating operation.

7. The air conditioner according to claim 2, further comprising:
an exhaust-heat recovery device configured such that a heat exchange medium thereof recovers heat of exhaust gas from the engine; and
an exhaust-heat heat exchanger configured such that heat is exchanged between the heat exchange medium and the refrigerant circulating in the heat pump cycle, wherein
the exhaust-heat heat exchanger is arranged in parallel with the first water-refrigerant heat exchanger such that the refrigerant discharged from the compressor flows into at least one of the first water-refrigerant heat exchanger and the exhaust-heat heat exchanger,
the heat pump cycle is configured such that the refrigerant in the heat pump cycle flows into the exhaust-heat heat exchanger, the heat of the exhaust gas is absorbed by the refrigerant, and the air to be supplied to the vehicle compartment is heated in the indoor heat exchanger by using the heat of the refrigerant that has absorbed the heat of the exhaust gas when the heating capacity is not obtained by flowing the coolant through the inside of the indoor heat exchanger, and when a coolant temperature is lower than a predetermined temperature in the heating operation, and
the heat pump cycle is configured such that the coolant flows through the first water-refrigerant heat exchanger and the refrigerant in the heat ₚump cycle flows into the first water-refrigerant heat exchanger when the heating capacity is not obtained by flowing the coolant through the inside of the indoor heat exchanger, and when the coolant temperature is increased to equal to or higher than the predetermined temperature in the heating operation.

8. The air conditioner according to claim 1, wherein
the high-pressure side heat exchanger is a radiator that radiates the heat of the refrigerant to the air to be supplied to the vehicle compartment,
the coolant circuit includes first to third coolant circuits,
a radiator that radiates the heat of the coolant to outside is arranged in the first coolant circuit and the coolant circulates through the radiator and the engine in the first coolant circuit,
the coolant circulates through the first water-refrigerant heat exchanger and the engine in the second coolant circuit,
the coolant circulates through the first water-refrigerant heat exchanger, the engine and the inside of the indoor heat exchanger in the third coolant circuit,
the heat pump cycle is configured such that circulating of the refrigerant in the heat pump cycle is stopped, and the coolant circulates in the third coolant circuit when the heating capacity is obtained by flowing the coolant through the inside of the indoor heat exchanger in the heating operation, and
the heat pump cycle is configured such that the refrigerant circulates in the heat pump cycle and the coolant circulates in the second coolant circuit when the heating capacity is not obtained by flowing the coolant through the inside of the indoor heat exchanger in the heating operation.

9. The air conditioner according to claim 8, wherein
the radiator as the high-pressure side heat exchanger is arranged downstream of an air flow of the, indoor heat exchanger in the third coolant circuit.
